(19) United States
(12) Patent Application Publication
(10) Pub. No.: US 2023/0363319 A1
(43) Pub. Date: Nov. 16, 2023

(54) PLANT TRIMMING APPARATUS AND METHODS

(71) Applicant: KOALA TRIMMERS, INC., Camas, WA (US)

(72) Inventor: Bryan WIRTH, Camas, WA (US)

(21) Appl. No.: 18/028,430

(22) PCT Filed: Oct. 20, 2021
(86) PCT No.: PCT/US2021/055921

§ 371 Date: Mar. 24, 2023

(30) Foreign Application Priority Data
Oct. 20, 2020 (US) 63094040

(51) Int. Cl. A01G 3/037; B26D 7/26

(52) U.S. Cl. CPC A01G 3/037; B26D 7/2635

(57) ABSTRACT

A trimming apparatus includes a trimmer head assembly and trimmer head frame portion. The trimmer head assembly including a first wheel, a second wheel, a drive motor coupled to the first wheel, the trimmer head assembly first and second wheels in frictional contact with each other and their rotation axis defining a non-zero camber angle, A trimming apparatus may include a plurality of trimmer head assemblies arranged in a grid, and include movable grid flap assemblies. A trimming apparatus may include a plurality of trimmer head assemblies formed and distributed as a drum module, or a plurality of drum modules. A trimming apparatus may include a single trimmer head assembly with a handle for manual operation.

### FIELD OF THE INVENTION

The present invention relates to apparatus and methods for trimming leaves and other growth from plant products, and particularly for trimming leaves from cannabis buds while minimizing damage to the buds and loss of trichomes.

### BACKGROUND

Various species and strains of cannabis are legally cultivated in order to harvest and process the infructescence of the plants (commonly referred to as “buds”), which contain concentrations of cannabinoids, including but not limited to tetrahydrocannabinol (THC), cannabidiol (CBD) and cannabinol (CBN). Many cannabinoids are subject of research for medical uses, and recreational and religious uses of cannabis for its psychoactive effects is legal in many jurisdictions. The leaves and stalks of cannabis plants, especially species commonly referred to as industrial hemp, have industrial uses unrelated to the cannabinoids they produce due to their mechanical properties. The present invention is directed to processing of the cannabis buds in preparation for consumption and/or cannabinoid extraction processes.

Cannabis buds take the form of uneven, lumpy clumps of flowers which produce resin-containing glandular trichomes, as shown in FIG. 20. The buds contain the highest concentrations of cannabinoids in the plant and are most amenable to extraction processes and human consumption by smoking, vaporizing or eating. The trichome resins contain the highest concentrations of the primary psychoactive cannabinoids. Thus, the buds—and especially the trichomes—are the most valuable part of the cannabis. However, the buds and their trichomes are also very fragile. Harvested buds also contain leaves growing through and extend out from the bud structure, which are not consumable, do not contain high concentrations of desired cannabinoids and which can interfere with downstream cannabinoid extraction processes.

Current methods to remove leaves from plant buds such as cannabis buds include manual trimming with scissors and mechanical systems, each of which have serious drawbacks. Hand trimming using scissors is slow, expensive and can create problems related to repetitive stress injuries. An experienced person using scissors can manage to process, under ideal conditions, approximately one pound of product per four hours: at a $15 per hour wage this equates to $60 per pound of product. However, manual trimming causes substantial loss of trichomes due to the inherently rough handling when trying to remove leaves from their stem-attachment points inside the buds, and even experienced trimmers inadvertently cut away valuable flowers. It is also difficult to recover this from the gloves and clothing of the person, and trimmers working in a high-throughput facility may have to wear respirators, further reducing accuracy and efficiency.

Mechanical trimming apparatus exist, but they cause substantial loss of trichomes, damage the buds and only remove leaves to the “zero-plane” level. Existing mechanical apparatus generally consist of a rotating drum into which buds are placed (or dumped in a continuous system). The drum has apertures which part of the leaves may poke through as a bud tumbles within the drum and external trimmers which will cut whatever projects through the apertures, but which do not remove anything that does not project through the apertures—hence the term “zero-plane”, which refers to the exterior surface of the drum. In addition to failing to remove substantial amounts of leaf contaminant which do not project past these zero-plane trimmers cut away valuable parts of the bud which project through the apertures, because the buds are naturally lumpy and uneven. This lost product—i.e. portions of the buds, which contain high trichome concentrations—is difficult to recover because it is mixed with leaf trimmings. The economic loss is substantial. Additionally, such systems are not easily scalable, and cannot be adjusted for different species, strains, or conditions (such as varying moisture content, temperature and humidity, varying bud structures, and other processing conditions)—the drum apertures are fixed in size and orientation. Such systems are also not easily cleaned of product sticking to the surfaces—another loss of value and leading to cross-contamination of products.

Thus, there is a need for apparatus and methods to remove the leaves and other non-cannabinoid containing, non-trichome containing, growths from cannabis buds beyond the zero-plane with minimum loss of the flowers and trichomes which produce the primary economic value of the crop. The apparatus and methods should be easily scalable and permit adjustments to critical process parameters to account for varying conditions and products.

### SUMMARY AND ADVANTAGES

A trimming apparatus includes a trimmer head assembly and trimmer head frame portion. The trimmer head assembly including a first trimmer head assembly wheel having a first trimmer head assembly rotational axis and a first trimmer head assembly wheel perimeter surface, a trimmer head assembly second wheel having a trimmer head assembly second rotation axis and trimmer head assembly second wheel perimeter surface, a trimmer head assembly drive motor coupled to the trimmer head assembly first wheel, the trimmer head assembly first wheel and trimmer head assembly second wheel rotationally mounted within the trimmer head assembly frame portion, the trimmer head assembly first and second wheels in frictional contact with each other at a location on their respective perimeter surfaces, wherein the trimmer head assembly first and second rotational axes define a non-zero trimmer head assembly camber angle.

A trimming apparatus may include a noncontact magnetic bearing assembly supporting the trimmer head assembly second wheel.

A trimming apparatus may include a plurality of trimmer head assemblies arranged in a grid, and include movable grid flap assemblies.

A trimming apparatus may include a plurality of trimmer head assemblies formed and distributed as a drum module, or a plurality of drum modules.

A trimming apparatus may include a single trimmer head assembly coupled to a handle and battery or other power supply, with an adjustable frame shield, for manual use.

The invention as described and claimed herein provides a number of advantages, including but not limited to: (1) pulling leaves and other projections from their bases rather than cutting them at the surface of a product; (2) causing less damage to the plant product being de-leaved or de-kerfed, especially regarding cannabis buds and trichomes; (3) the system is modular and infinitely scalable; (4) the system is easily automated; (5) the system may be provides with a contained environment with separate ventilation system from operators/workers, and which may be efficiently scrubbed of noxious odors prior to discharge; (6) the system may be operated in a continuous, batch or manual mode. Other advantages will become apparent upon review of the Description, Drawings and Claims.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

FIG. 1 shows an exploded view of a first embodiment.

FIG. 1A shows a partially exploded top perspective view of second embodiment.

FIG. 2A shows backside view of a trimmer drive wheel frame.

FIG. 2B shows a cutaway side view of a trimmer drive wheel frame with outer band.

FIG. 3A shows a cutaway side view of a trimmer idler wheel.

FIG. 3B shows a perspective view of a back side of a trimmer idler wheel.

FIG. 3C shows a perspective view of a front side of a trimmer idler wheel.

FIG. 4 shows a view of a drive wheel and idler wheel and camber angle.

FIG. 5A shows a perspective top view of a middle grid arm.

FIG. 5B shows a cutaway side view of a middle grid arm.

FIG. 5C shows a top view of a middle grid arm.

FIG. 6A shows a perspective bottom view of a middle grid flap.

FIG. 6B shows a cutaway side view of a middle grid flap.

FIG. 6C shows a top view of a middle grid flap.

FIG. 6D shows a front edge view of a middle grid flap.

FIG. 7A shows a top perspective view of a trimmer base portion.

FIG. 7B shows a cutaway side view of a trimmer base portion.

FIG. 8A shows a perspective view of a banjo retaining ring.

FIG. 8B shows a perspective view of a banjo center ring.

FIG. 9 shows a rotated perspective view of a left grid arm.

FIG. 10A shows a bottom perspective view of a left grid flap.

FIG. 10B shows a cutaway side view of a left grid flap.

FIG. 10C shows a front edge view of a left grid flap.

FIG. 11 shows a perspective view of a right grid arm.

FIG. 12A shows a bottom perspective view of a right grid flap.

FIG. 12B shows a cutaway side view of a right grid flap.

FIG. 12C shows a front edge view of a right grid flap.

FIG. 13A shows perspective view of a base plate bottom portion.

FIG. 13B shows a perspective view of a base plate middle portion.

FIG. 13C shows a perspective view of a base plate top portion.

FIG. 14 shows a side view of a single right trimmer assembly.

FIG. 15A shows a side view of a right trimmer assembly with grid flap depressed.

FIG. 15B shows a side view of a right trimmer assembly with grid flap elevated.

FIG. 16 shows a front perspective view of part of a grid table and trimmer assemblies (trimmer drive wheels shown in white, trimmer idler wheels shown in black).

FIG. 17 shows a front perspective view of part of a grid table and trimmer assemblies and base plate (trimmer drive wheels shown in white, trimmer idler wheels shown in black).

FIG. 18 shows a front left perspective view of part of a grid table and trimmer assemblies (trimmer drive wheels shown in white, trimmer idler wheels shown in black).

FIG. 19A shows a discharge end perspective view of a system, partially assembled with shield in place.

FIG. 19B shows a side view of a system, partially assembled with top shield portion removed.

FIG. 20 shows a view of an untrimmed cannabis bud.

FIG. 21 shows a side view of a second embodiment.

FIG. 22 shows a close-up exterior view of a second embodiment.

FIG. 23 shows an end view of a second embodiment.

FIG. 24 shows a trimmer head assembly of a second embodiment.

FIG. 25A shows a trimmer head frame of a second embodiment.

FIG. 25B shows a trimmer head frame of a second embodiment.

FIG. 26 shows a trimmer head assembly.

FIG. 27A shows a trimmer head assembly drive motor bracket.

FIG. 27B shows a trimmer head assembly drive motor bracket.

FIG. 28 shows an exploded view of a trimmer second wheel and magnetic bearings.

FIG. 29 shows an end view of a second embodiment.

FIG. 30 shows an end view of a second embodiment.

FIG. 31 shows a partially exploded of a portion of a second embodiment.

FIG. 32 shows a schematic view of a second embodiment inclinator.

FIG. 33 shows a simplified partial schematic view of a controller of a second embodiment.

FIG. 34 shows a side view of a third embodiment.

FIG. 35 shows a fourth embodiment.

### REFERENCE NUMBERS USED IN DRAWINGS

Turning now descriptively to the drawings, in which similar reference characters denote similar elements throughout the several views, the figures illustrate the _ of the present invention. With regard to the reference numerals used, the following numbering is used throughout the various drawing figures:

### REF. NR. DESCRIPTION

10 First Embodiment
12 Middle trimmer Assembly
14 Left Trimmer Assembly
16 Right Trimmer Assembly
18 Base Plate
20 Grid Table
22 Grid Receiving End
24 Grid Discharge End
26 Process Path
28 Shield
30 Shield Bottom Portion
32 Shield Top Portion
34 Exhaust Ports
36 Base Plate Bottom Portion
38 Base Plate Middle Portion
40 Base Plate Top Portion
42 Base Plate Wire Channels
44 Base Plate Female Electrical Connectors
46 Trimmer Stand
48 Trimmer Stand Base Portion
50 Trimmer Stand Base Portion First Pedestal
52 Trimmer Stand Base Portion Second Pedestal
54 Trimmer Stand Base Portion Third Pedestal
56 Trimmer Stand Base Portion Fourth Pedestal
58 Trimmer Head Rotatable Coupler
60 Trimmer Head
62 Trimmer Head First Shell
64 Trimmer Head Second Shell
66 Trimmer Drive Motor
68 Grid Flap Motor
70 First Trimmer Wheel/Drive Wheel
72 Second Trimmer Wheel/Idler Wheel
74 Banjo Assembly
76 Pull Angle
78 Trimmer Drive Wheel Rotational Axis
80 Trimmer Idler Wheel Rotational Axis
82 Trimmer Drive Wheel Perimeter
84 Trimmer Idler Wheel Perimeter
86 Trimmer Wheel Camber Angle
88 First/Drive Wheel Beveled Edge Surface
90 Second/Idler Wheel Beveled Edge Surface
92 First/Drive Wheel Bevel Angle
94 Second/Idler Wheel Bevel Angle
96 Trimmer Assembly Yaw Angle
98 Drive Wheel Rigid Frame
100 Drive Wheel Outer Band
102 PLC Control System
104 Touch Panel
106 Idler Wheel Bearings
108 Middle grid Flap Assembly
110 Left Grid Flap Assembly
112 Right Grid Flap Assembly
114 Middle Grid Arm
116 Middle Grid Arm First Extension Arm
118 Middle Grid Arm Second Extension Arm
120 Middle Grid Arm Channel
122 Middle Grid Flap
124 Middle Grid Flap Top Surface
126 Middle Grid Flap Bottom Surface
128 Middle Grid Flap First Lateral Bite
130 Middle Grid Flap Second Lateral Bite
132 Banjo Cam Arm Bull Joint Portion
134 Middle Grid Flap Ball Joint Socket
136 Middle Grid Flap Hinge Portion
138 Middle Grid Flap Grid Arm Hinge Portion
140 Banjo Center Ring
142 Banjo Retaining Ring
144 Banjo Cam Arm
146 Banjo Center Ring Offset Coupling
148 Banjo Center Ring Outer Perimeter Surface
150 Banjo Retaining Ring Inner Perimeter Surface
152 [Not used]
154 Left Grid Arm
156 Left Grid Arm First Extension Arm
158 Left Grid Arm Second Extension Arm
160 Left Grid Arm Channel
162 Left Grid Flap
164 Left Grid Arm Bumper Portion
166 Left Grid Flap Top Surface
168 Left Grid Flap Bottom Surface
170 Left Grid Flap Ball Joint Socket
172 Left Grid Flap Hinge Portion
174 Left Grid Arm Hinge Portion
176 Right Grid Arm
178 Right Grid Arm First Extension Arm
180 Right Grid Arm Second Extension Arm
182 Right Grid Arm Channel
184 Right Grid Flap
186 Right Grid Arm Bumper Portion
188 Right Grid Flap Top Surface
190 Right Grid Flap Bottom Surface
192 Right Grid Flap Ball Joint Socket
194 Right Grid Flap Hinge Portion
196 Right Grid Arm Hinge Portion
198 Left Grid Flap First Bite
200 Right Grid Flap First Bite
202 Left Grid Flap Second Bite
204 Right Grid Flap Second Bite
206 System Inlet/Feed
208 System Outlet/Discharge
210 First Trunnion
212 Second Trunnion
214 Trimmer Head Clip
216 Middle Grid Arm Upstream Portion
218 Middle Grid Arm Upstream Portion Top Surface
1010 Second Embodiment
1012 Trimmer Head Assembly
1014 Trimmer Head Frame Portion
1016 Trimmer Head Assembly First Wheel
1018 Trimmer Head Assembly First Rotational Axis
1020 Trimmer Head Assembly First Wheel Perimeter
1022 Trimmer Head Assembly First Wheel Perimeter Surface
1024 Trimmer Head Assembly First Wheel Contact Layer
1026 Trimmer Head Assembly Second Wheel
1028 Trimmer Head Assembly Second Rotational Axis
1030 Trimmer Head Assembly Second Wheel Perimeter
1032 Trimmer Head Assembly Second Wheel Perimeter Surface
1034 Trimmer Head Assembly Second Wheel First Face
1036 Trimmer Head Assembly Second Wheel First Bearing Race
1038 Trimmer Head Assembly Second Wheel Second Face
1040 Trimmer Head Assembly Second Wheel Second Bearing Race
1042 Trimmer Head Assembly Second Wheel Bearing Assembly
1044 First Magnetic Retaining Ring
1046 First Magnetic Bearing Ring First Face
1048 First Magnetic Bearing Ring Second Face
1050 Second Magnetic Retaining Ring
1052 Second Magnetic Bearing Ring First Face
1054 Second Magnetic Bearing Ring Second Face
1056 First Outer Magnet
1058 First Outer Magnet First Face
1060 First Outer Magnet Second Face
1062 First Outer Magnet Beveled Perimeter
1064 Second Outer Magnet
1066 Second Outer Magnet First Face
1068 Second Outer Magnet Second Face
1070 Second Outer Magnet Beveled Perimeter
1072 Trimmer Head Assembly Frictional Contact Location
1074 Trimmer Head Assembly Camber Angle
1076 Trimmer Head Assembly Pull Angle
1078 Trimmer Head Assembly Impulse Angle
1080 Trimmer Head Assembly Drive Motor
1082 Drive Motor Mounting Bracket
1084 Head Assembly Frame Shield Portion
1086 Head Assembly Frame Shield Portion Aperture
1088 Head Assembly Frame Shield Portion Aperture First Wheel Receiving Portion
1090 Head Assembly Frame Shield Portion Aperture Second Wheel Retaining Portion
1092 Head Assembly Frame Shield Portion Aperture Second Wheel Retaining Portion First Sidewall
1094 Head Assembly Frame Shield Portion Aperture Second Wheel Retaining Portion Second Sidewall
1096 Trimmer Head Depth
1098 Drum Module
1100 Drum Module First End
1102 Drum Module Second End
1104 Drum Module Rotation Axis
1106 Drum Module Frame
1108 Drum Module Frame Interior Surface/Zero Depth
1110 Drum Module Frame Exterior Surface
1112 Drum Module Interior Volume
1114 Drum Module Ring
1116 Drum Module Ring Offset Angle
1118 Drum Module Trimmer Head Assembly Distribution Pattern
1120 Drum Rotational Drive
1122 Drum Module Drive Wheel
1124 Drum Module Inclinator
1126 Drum Module Incline Angle
1128 Drum Module Inclinator Lead Screw
1130 Drum Module Inclinator Lead Screw Drive
1132 Drum Module Connection Collar
1134 Slip Ring Assembly
1134a Slip Ring Assembly First Ring
1134b Slip Ring Assembly First Brush
1134c Slip Ring Assembly Second Ring
1134d Slip Ring Assembly Second Brush
1136 Trimmer Head Assembly Drive Motor Controller
1138 System Controller
1140 Support Frame
2010 Third Embodiment
2098A First Drum Module
2098B Second Drum Module
2098C Third Drum Module
2104 Processing Cylinder Rotation Axis
2112 Processing Cylinder Continuous Interior Volume
2118A First Drum Module Trimmer Head Assembly Distribution Pattern
2118B Second Drum Module Trimmer Head Assembly Distribution Pattern
2118C Third Drum Module Trimmer Head Assembly Distribution Pattern
2134 Drum Module Connection Collar
2140 Processing Cylinder
3010 Fourth Embodiment
3012 Trimmer Head Assembly
3014 Trimmer Head Assembly Frame Portion
3084 Depth Control Shield
3086 Depth Control Shield Front Side
3088 Depth Control Shield Back Side
3096 Head Depth
3142 Handle Portion
3144 Threaded Spacers
3146 Battery

### DETAILED DESCRIPTION

Before beginning a detailed description of the subject invention, mention of the following is in order. When appropriate, like reference materials and characters are used to designate identical, corresponding, or similar components in differing figure drawings. The figure drawings associated with this disclosure typically are not drawn with dimensional accuracy to scale, i.e., such drawings have been drafted with a focus on clarity of viewing and understanding rather than dimensional accuracy.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

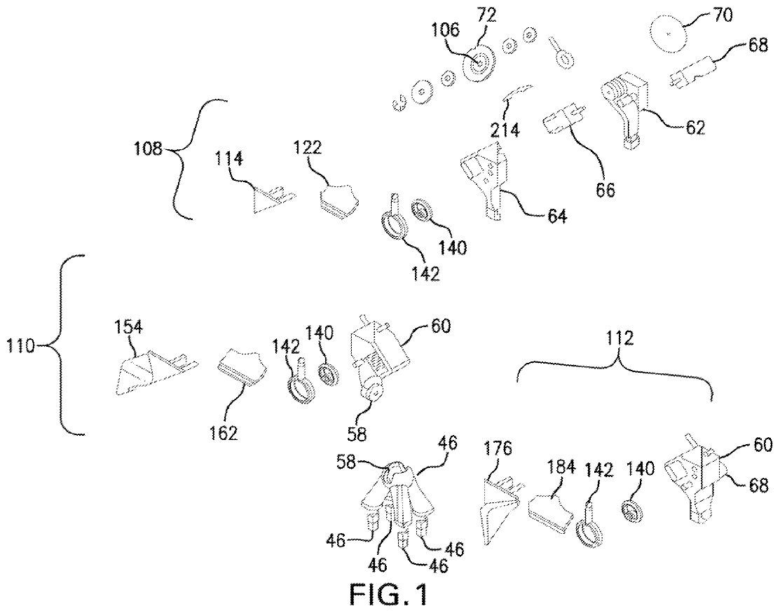

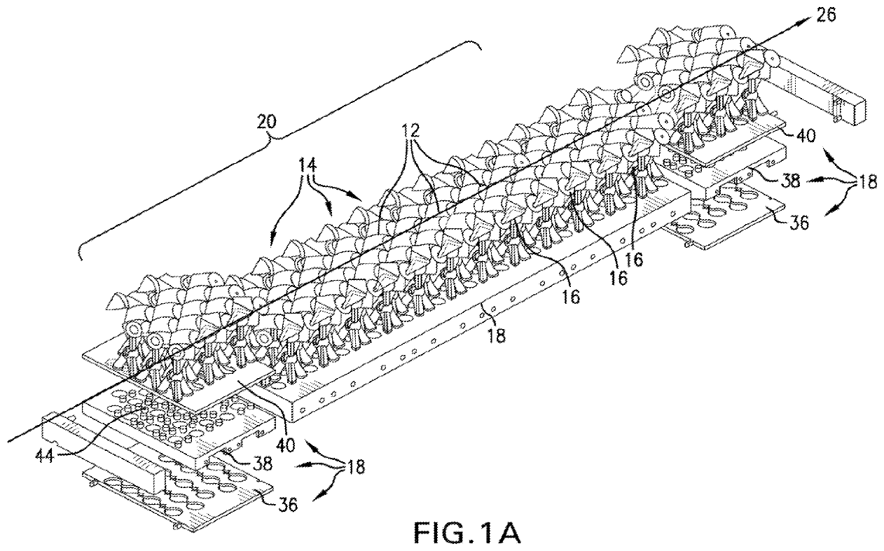

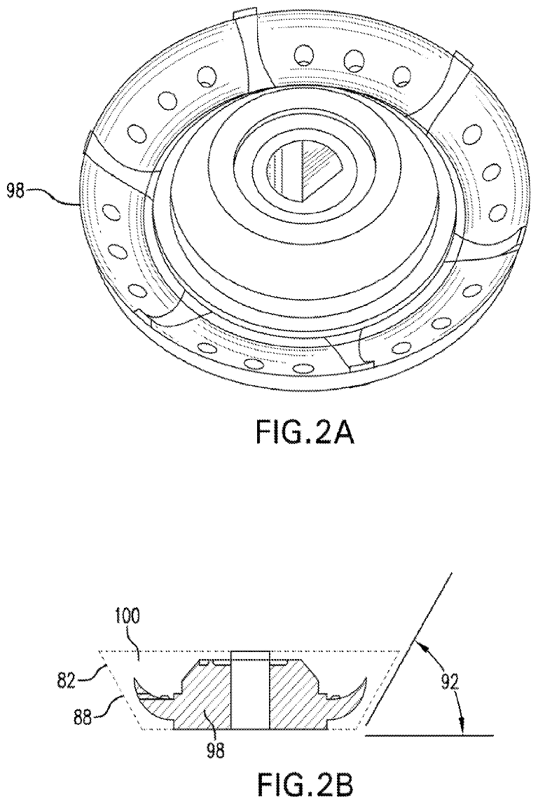

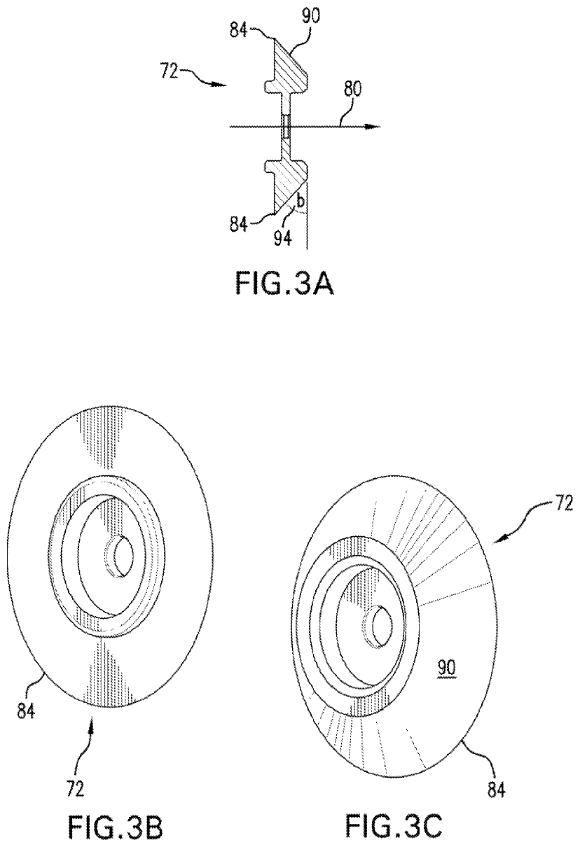

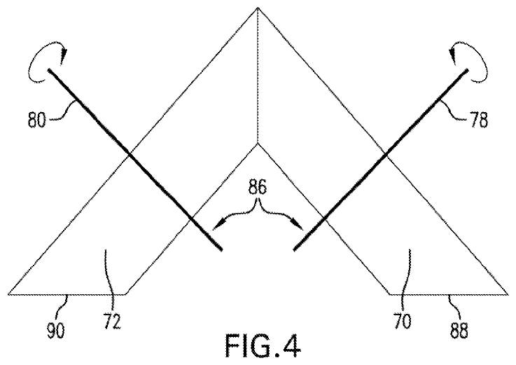

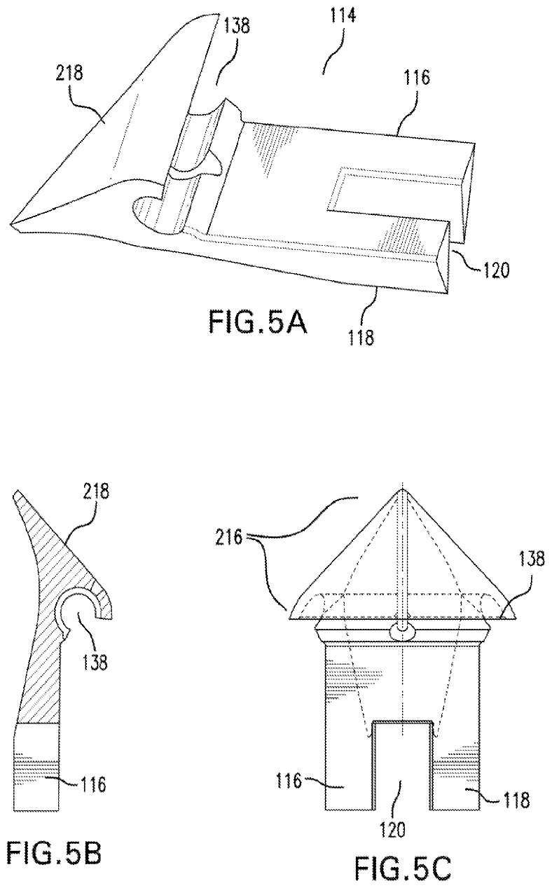

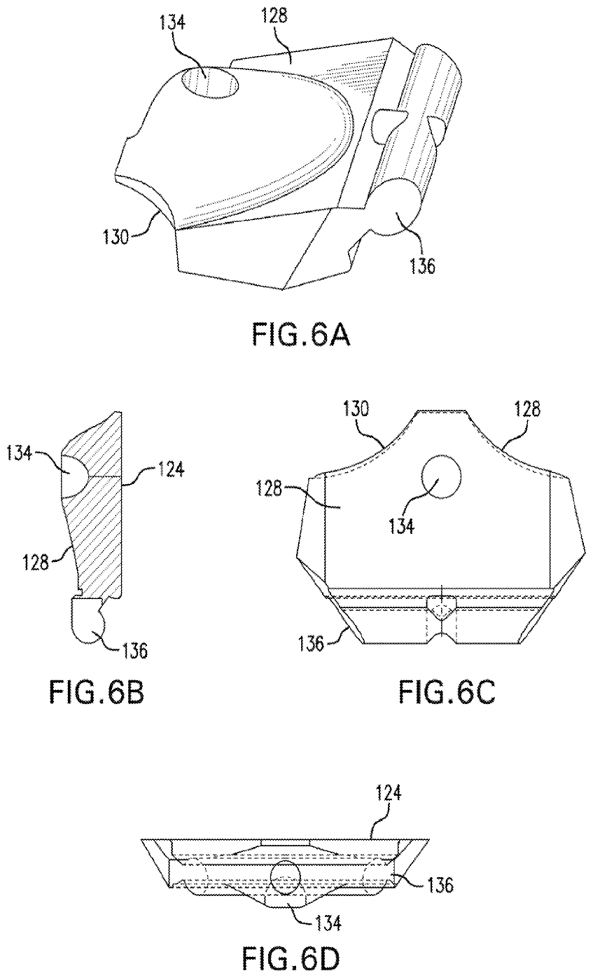

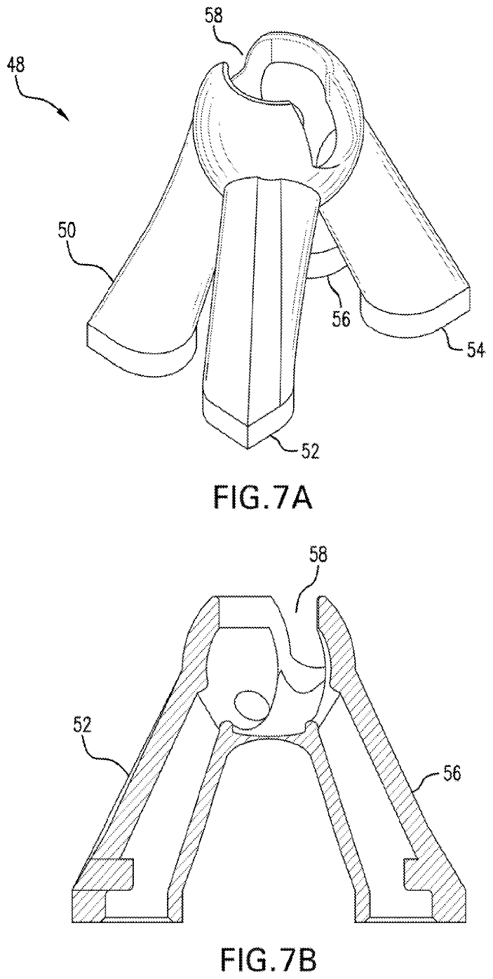

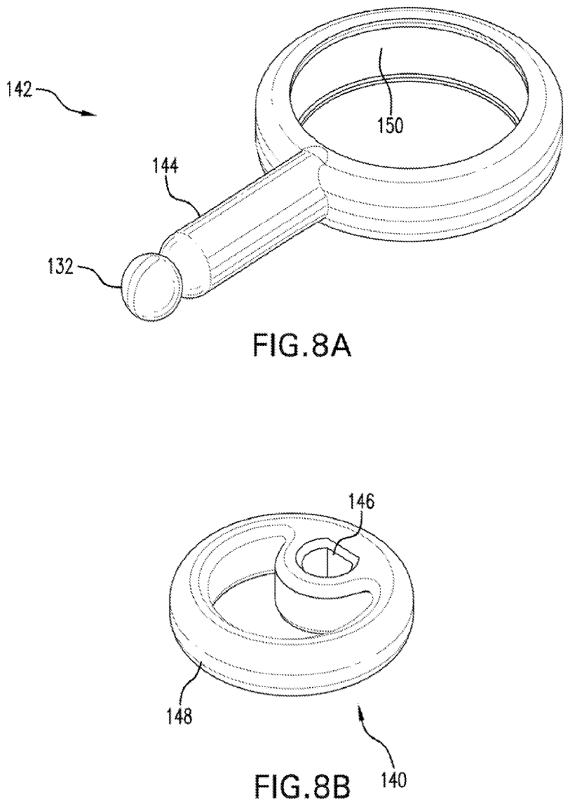

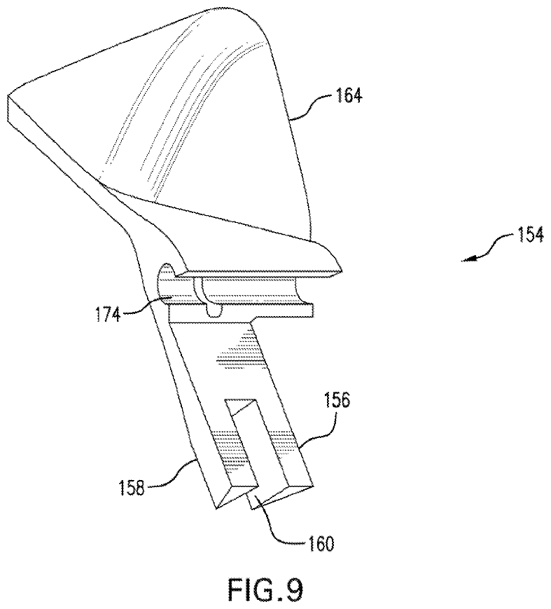

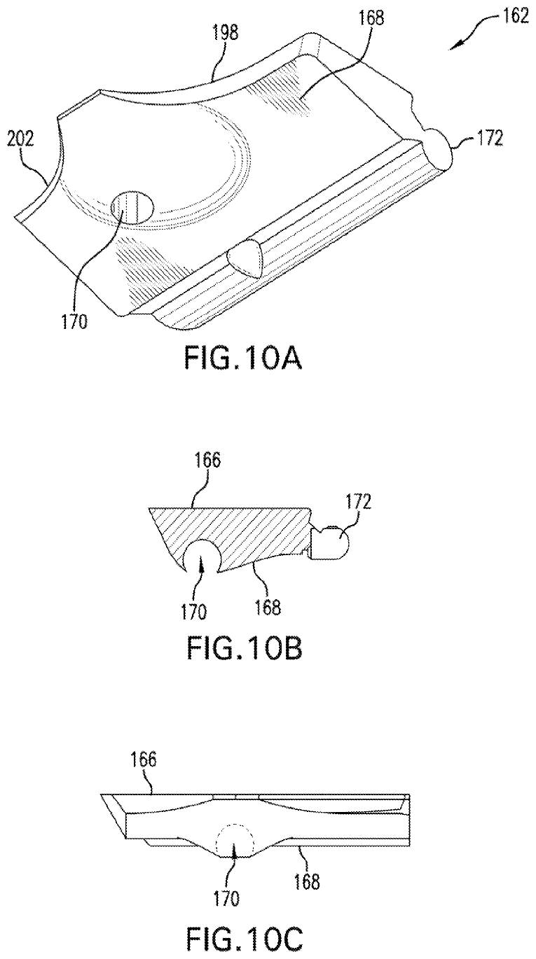

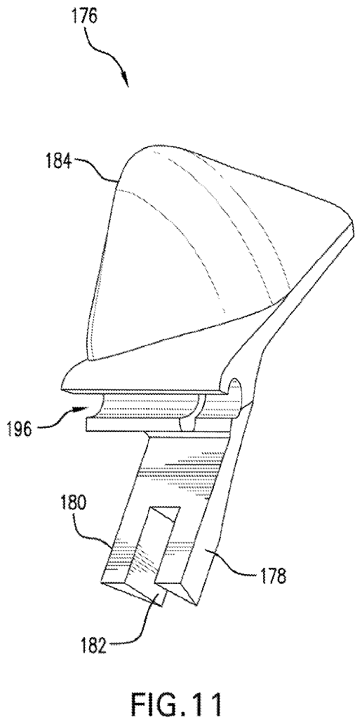

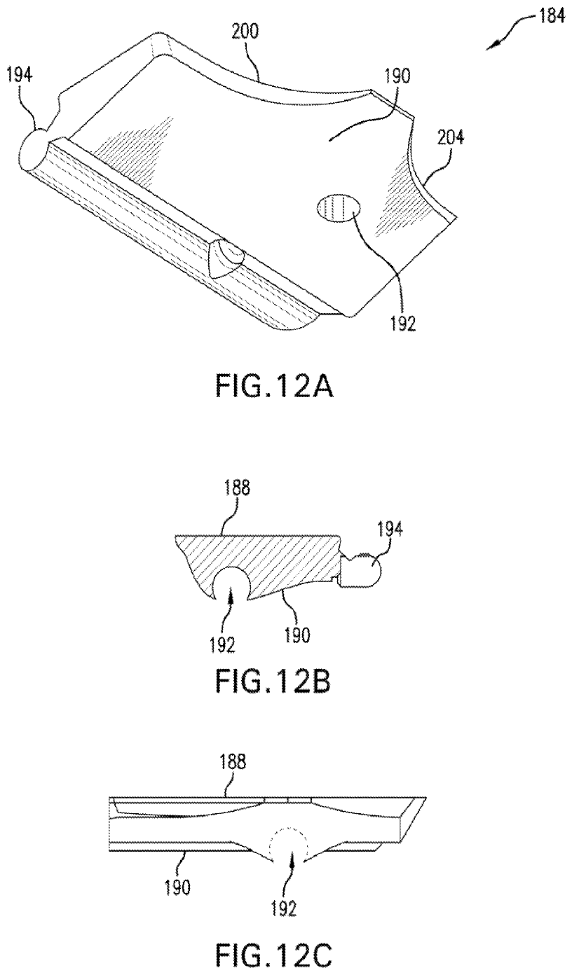

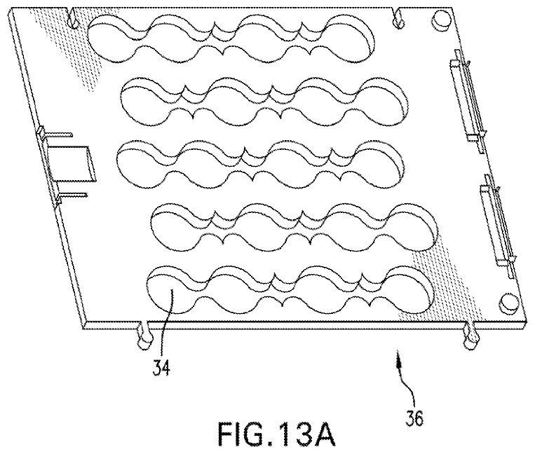

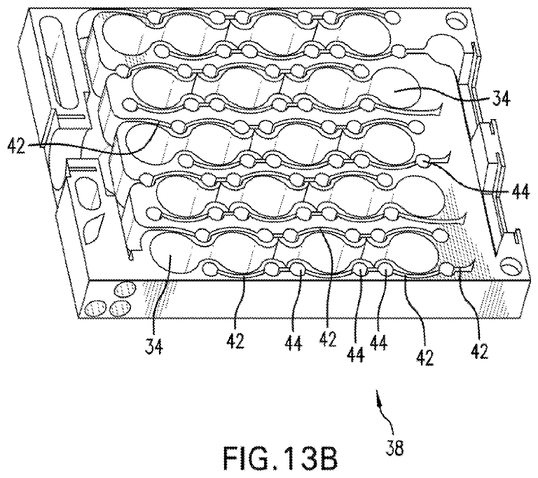

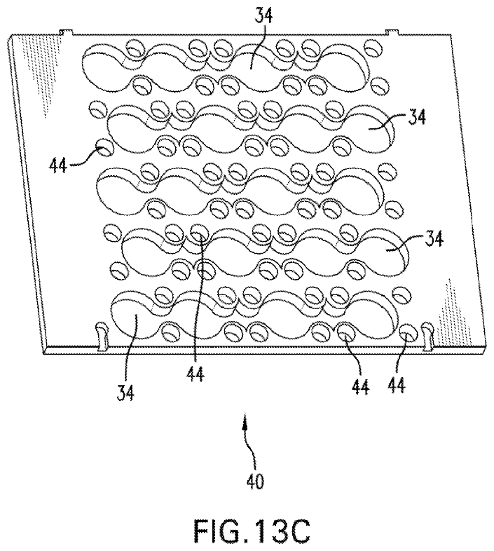

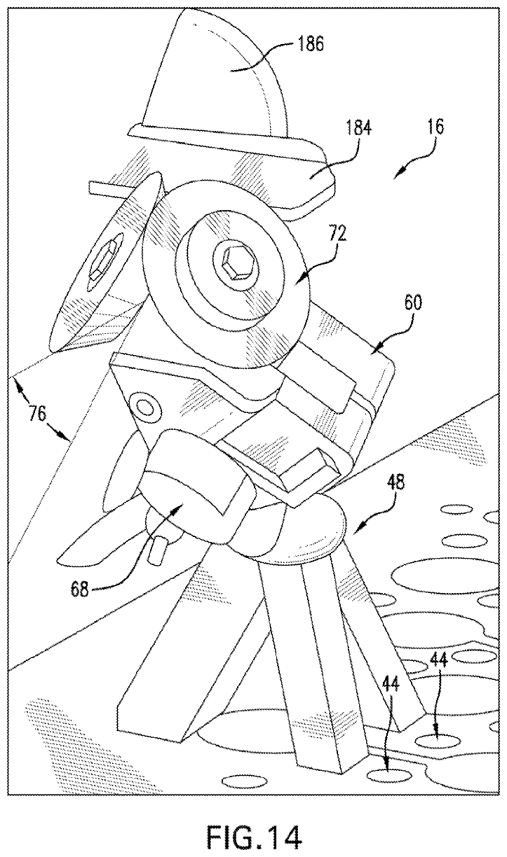

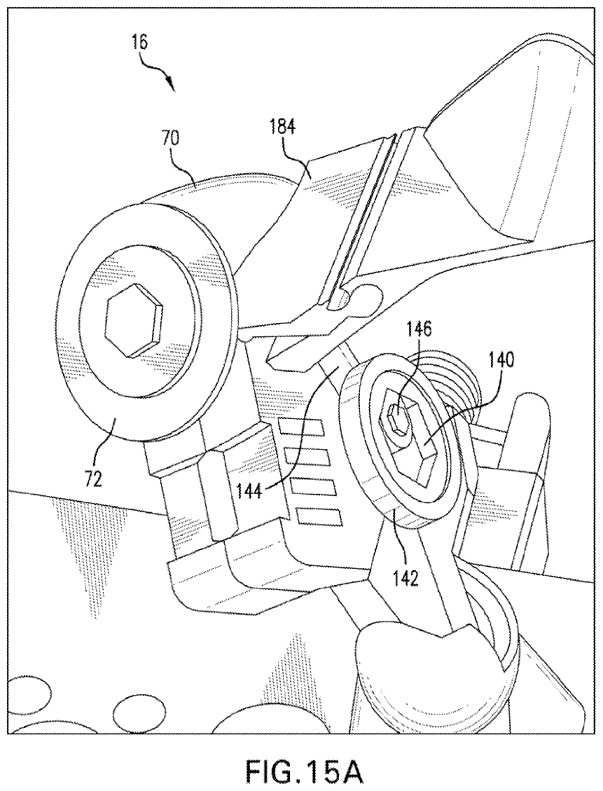

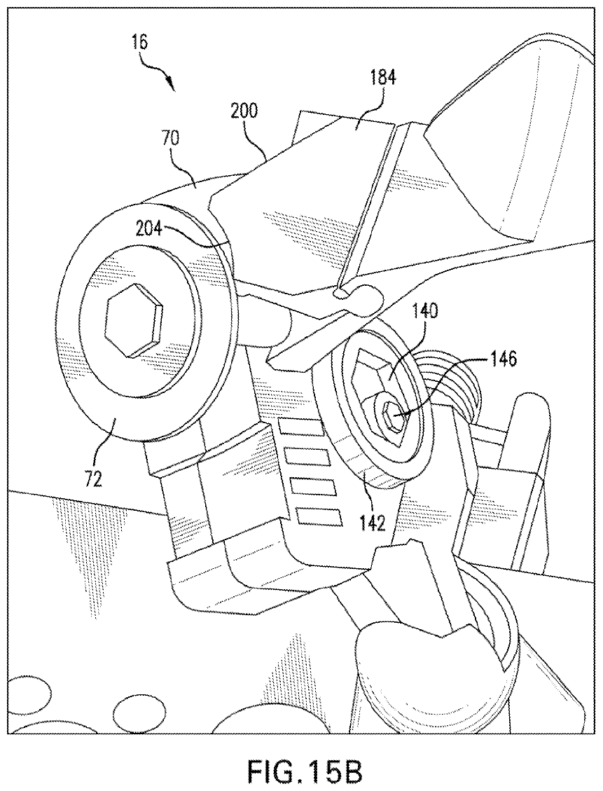

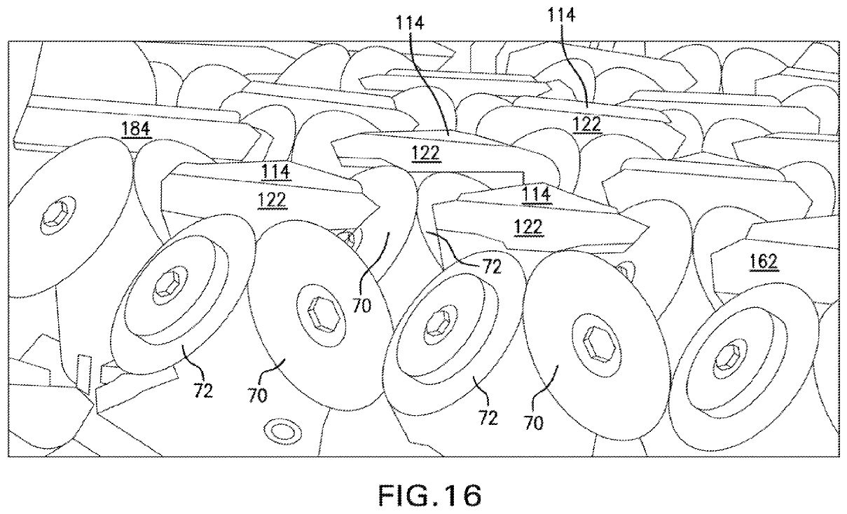

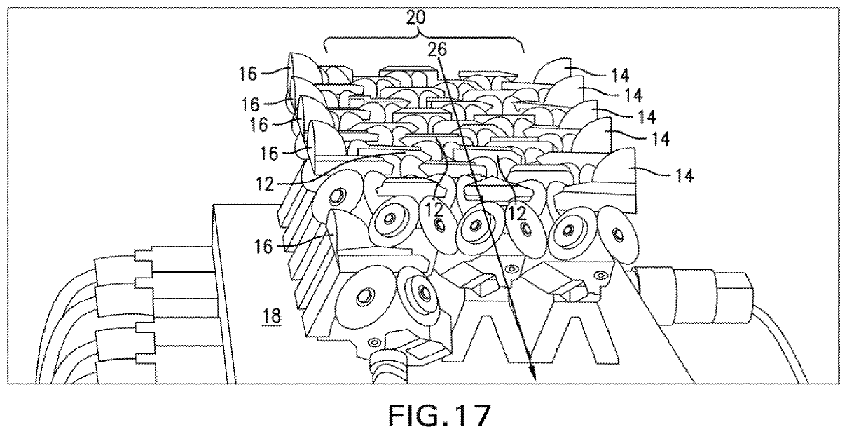

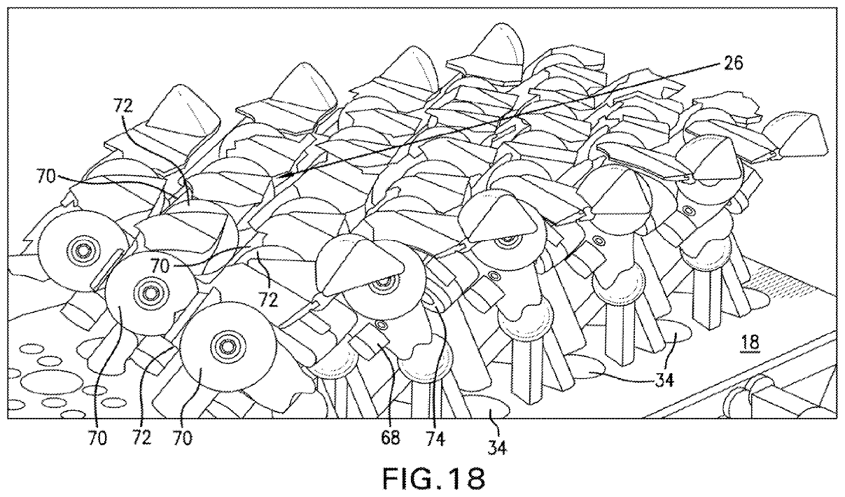

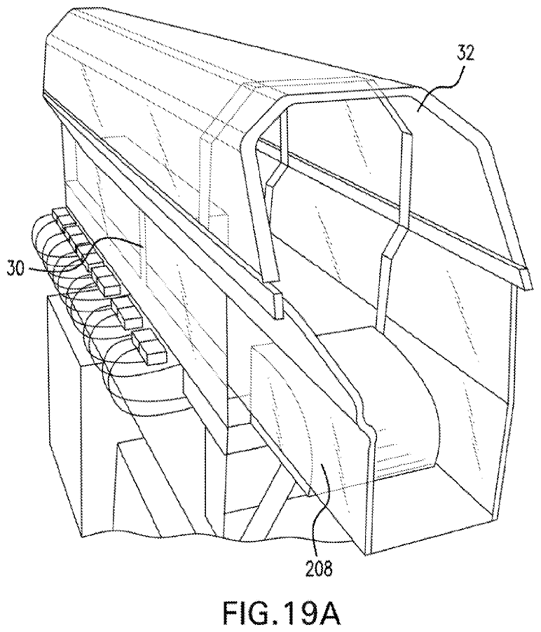

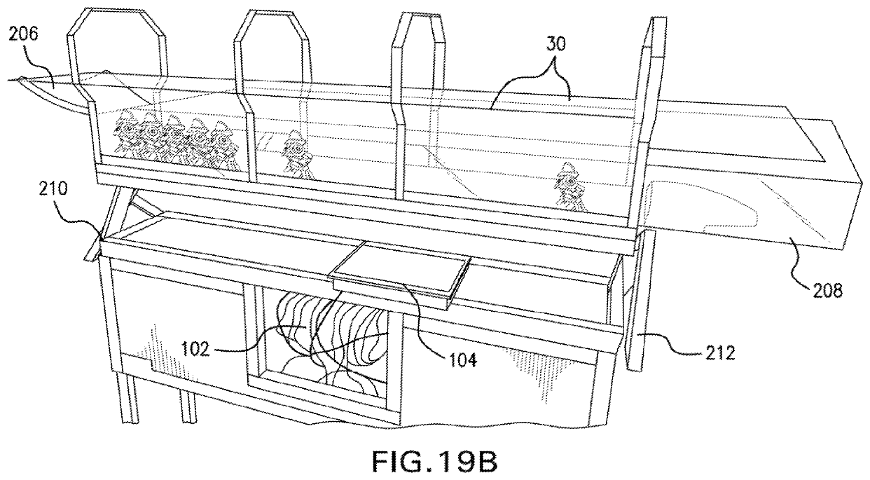

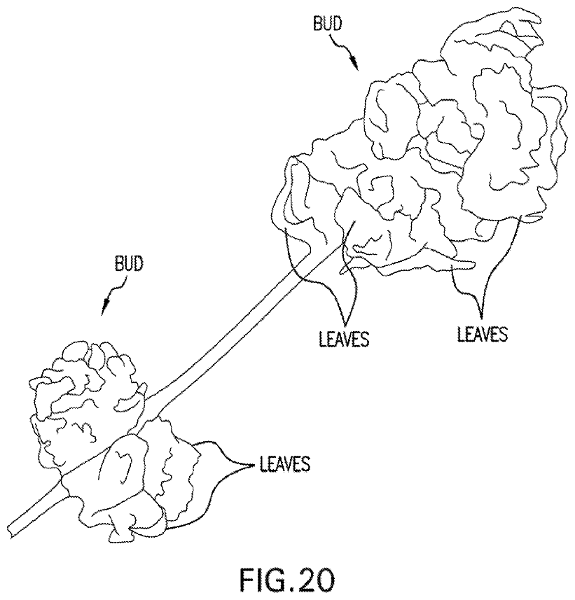

Referring to FIGS. 1-19B, a first embodiment of a trimming apparatus 10 is shown. The first embodiment includes a plurality of middle trimmer assemblies 12, left trimmer assemblies 14 and right trimmer assemblies 16, each connected to base plate 18 which together define a processing bed or grid table 20 able to receive product at a grid receiving end 22 and discharge product at a grid discharging end 24 and defining a process path 26.

Removable shield 28 goes over grid table 20 and base plate 18. In the embodiment, removable shield 28 includes a bottom portion 30 and top portion 32, permitting easy access for maintenance and lighter weight. Removable shield 28 is made from clear acrylic material, which provides visibility and is noncontaminating to the product. Exhaust ports 34 are provided to draw ventilation air from above the grid table 20 through base plate 18 and out of the system 10. This provides cooling air to components, draws the removed leaf material down and away from grid table 20, reduces noxious smells from the processing area and allows for exhaust air to be directed to scrubber systems which may be required to remove noxious smells and/or fumes before discharging to the local environment. Additionally, the combination of shield 28 and exhaust ports 34 allows more precise control of temperature and humidity conditions of the product, which must be stored in sealed containers prior to and after processing to prevent degradation. Shield 28 may include coatings to block UV light from the product, which can accelerate degradation.

In the embodiment, base plate 18 is a 3D-printed board providing a mechanical foundation and electrical and control functions. Base plate 18 may comprise multiple modules coupled together to form a single base plate 18 supporting a continuous grid table 20. Base plate 18 includes a bottom portion 36, a middle portion 38 and a top portion 40. Middle portion 38 includes wire channels 42 to route the power and control wiring for motor and sensors. Base plate top portion 40 and bottom portion 36 sandwich and seal base plate middle portion 38. Base plate top portion includes female electrical connectors 44 which mate to trimmer assembly male electrical connectors 46 to transmit electrical power and control signals. Base plate 28 is coated with a ceramic coating to minimize buildup of resinous trichome material and provide easier cleaning.

Each middle, left and right trimmer assembly 12, 14, 16, includes a trimmer stand 46 which provides electrical and control communication connections to the trimmer drive wheel motor 66 and trimmer grid flap motor 68, as well as the mechanical connection for the physical assemblies. Trimmer stand 46 includes a base portion 48 connectable to the base plate 18 and a trimmer head 62 which provides mounting for the trimmer wheels, motors and bearings. In the embodiment, middle trimmer stand base portion 48 includes four pedestals 50, 52, 54, 56, each of which carry internal conductors to transmit electrical power and control signals to the motors of the respective trimmer assembly 12, 14, 16 from base plate 18. Pedestals 50-56 also are the structural support members for the trimmer assemblies 12, 14, 16. Each trimmer stand 46 includes trimmer head rotatable coupler 58 to receive trimmer head 60. Trimmer stand base portion 48 is coated with a ceramic coating to minimize buildup of resinous trichomes and provide easier cleaning.

In the embodiment each trimmer head 60 includes opposed first and second trimmer head shells 62, 64, respectively, which are mated using friction fittings and a trimmer head clip 214, defining cavities within which trimmer drive motor 66 and grid flap motor 68 and associated bearings are mounted. First and second trimmer head shells 62, 64 include vents to provide cooling to trimmer drive motor 66, grid flap motor 68, and bearings. In the embodiment, each trimmer head 60 includes a first trimmer wheel 70, second trimmer wheel 72, trimmer drive motor 66, grid flap assembly (middle grid flap assembly 108, left grid flap assembly 110 or right grid flap assembly 112), and grid flap motor 68. Trimmer head 60 is rotatably coupled to trimmer stand base portion 48 by rotational coupler 58 having an axis of rotation transverse to process path 26, providing ability to selectively adjust the pull angle 76 of each trimmer assembly 12, 14 and 16. First trimmer wheel 70—the trimmer drive wheel—is coupled to trimmer drive motor 66, defining a trimmer drive wheel rotational axis 78. Second trimmer wheel 72—the trimmer idler wheel—rotates freely about a trimmer idler wheel rotational axis 80. Trimmer drive wheel 70 and trimmer idler wheel 72 are in compression/frictional contact at the respective perimeters 82 and 84 of trimmer drive wheel 70 and trimmer idler wheel 72, such that trimmer drive motor 66 delivers rotational energy to trimmer idler wheel 72 via trimmer drive wheel 70. The frictional contact between trimmer drive wheel 70 and trimmer idler wheel 72 creates the friction-compression point which is able to grip projecting leaves from a cannabis bud and pull them off, removing leaf structures lying above zero-plane minimal harm to the trichome-rich infructescence.

Trimmer drive wheel rotational axis 78 and trimmer idler wheel axis 80 are nonparallel, creating a negative camber angle 86 (i.e. the bottoms of the wheels are farther apart than the tops of the wheels), similar to a bevel gear or angle gear system. The outer regions of trimmer drive wheel 70 and trimmer idler wheel 72 form a first and second beveled edge surface, 88 and 90, respectively. The bevel angles (or pitch angles) 92 and 94 of the first and second beveled edge surfaces 88 and 90 match to provide good contact and balanced force across the leaf surfaces during removal. In the embodiment, the sum of the bevel angles is approximately 90°.

In the embodiment, trimmer head rotatable coupler 58 is selectively adjustable to adjust pull angle 76. Optimum pull angle 76 may vary depending on the cannabis strain, average bud and leaf size, moisture content of the buds and leaves, and other factors. Generally, the contact region of trimmer drive wheel 70 and trimmer idler wheel 72 will be adjusted to slightly forward of top-dead-center, so the pull angle 76 is negative—i.e. slightly down and forward. Generally, a slightly negative pull angle 76 from −5° to −30° is preferable in order pass removed leaf materials downward but still impart sufficient forward momentum on the bud to cause it to progress longitudinally along process path 26.

Left and right trimmer assemblies 14 and 16 may be oriented with a left or right yaw angle 96 relative to process path 26 to urge product back toward the central region of grid table 20. In the described embodiment, the yaw angle is 0°.

In the embodiment, trimmer drive wheel 70 is formed of a rigid drive wheel frame 98 with a pliant gripping outer band 100 of silicone material molded around a rigid drive frame to form a beveled drive wheel perimeter edge 82. The silicone material provides grip to engage the leaves, is relatively nonstick—in relation to trichomes—so not subject to debris buildup and not difficult to recover trichome debris from its surfaces, which are the most economically valuable part of the cannabis buds. The pliancy and grip of the silicone also provide sufficient friction coefficient to engage and transfer rotational energy to the trimmer idler wheel 72, but not compressing the leaf material to the point that it crushes and cuts the leaf off at the point of contact, rather than pulling the leaf out substantially intact, thereby accomplishing leaf removal above the zero plane. The capability to pull leaves out and thereby remove unwanted material from the buds above the zero plane is unique and provides a significant advantage of the system over existing systems and methods. The pliant silicone outer band 100 also provides an easily replaceable nontoxic wear surface.

Drive wheel outer band 100 may have a round or oval cross section, similar to an o-ring, although this may be less efficient in gripping leaves and moving product forward.

Trimmer drive wheel 70 is coupled to trimmer drive motor 66. In the embodiment, trimmer drive motor 66 is a 24 vdc motor which provides individually controllable speed and direction control through the PLC control system 102 and portable touch panel 104.

In the embodiment, trimmer idler wheel 72 is made from ceramic-coated aluminum, forming a rigid opposing hard surface to trimmer drive wheel 70 and having a nonstick surface which avoids buildup of trichomes. Trimmer idler wheel 72 is rotatingly coupled to trimmer head 60 by magnetic bearings 106. Magnetic bearings 106 provide an extremely low friction coupling which requires non-contact coupling with no lubrication (avoiding potential contamination from particle shedding and leaks) and essentially no maintenance. Magnetic bearings 106 also are able to accommodate the non-axial flexing of trimmer idler wheel 72 as leaves of varying thicknesses and toughness are engaged between trimmer drive wheel 70 and trimmer idler wheel 72 and pass between them, as well as the non-axial force created at the compression-contact region between the wheels. Although seemingly small, these out-of-axis forces can create significant vibration and uneven wear patterns which would significantly shorten the life of mechanical bearings. Dry mechanical bearings and lubricated bearings can be used, and would function, but magnetic bearings 106 are preferred.

A plurality of middle grid flap assemblies 108, right grid flap assemblies 110 and left grid flap assemblies 112 form the grid table 20 along which product moves during processing. In the embodiment the middle grid flap assemblies 108 are identical to each other, and the right and left grid flap assemblies 110 and 112 are basically identical to each other but have grid arms 154 and 176 which are mirror images of each other.

Each of middle grid flap assemblies 108 includes a middle grid arm 114, middle grid flap 116 and banjo assembly 74. Middle grid arm 114 rigidly connects to trimmer head 60 via first and second middle grid arm extension arms 116 and 118, respectively, which are laterally displaced from each other to form a channel 120 for banjo cam arm 144 to move up and down against middle grid flap 122. Middle grid arm upstream portion 216 includes a flat top surface 218 to align with middle grid flap 122 when middle grid flap 122 is at its neutral position.

Each banjo assembly 74 couples to a grid flap motor 68 mounted to trimmer head 60. Each banjo assembly 74 includes a banjo center ring 140, banjo retaining ring 142 and banjo cam arm 144 extending from banjo retaining ring 142. Grid flap motor 68 is coupled to banjo center ring 140 by the banjo center ring offset coupling 146, with offset coupling 146 being offset from the center axis of banjo center ring 140 to create a cam effect which translates the rotational motion of grid flap motor 68 to a linear motion which raises and lowers middle grid flaps 122. Banjo cam arm 144 includes a male ball joint portion 132 to engage socket 134 on the bottoms of middle grid flap 122. Banjo center ring 140 has a convex rounded outer perimeter surface 148 and banjo retaining ring 142 has a corresponding concave interior perimeter surface 150 to maintain engagement while allowing some out-of-plane displacement as banjo cam arm 144 translates vertically and slightly fore and aft while engaged to a grid flap.

Middle grid flap 122 includes a top surface 124, bottom surface 126, hinge portion 136, and concave first and second lateral bites 128 and 130, similar to a truncated tractrix curve, which provide clearance for trimmer drive and idler wheels 70 and 72. In the embodiment, middle grid flap hinge portion 136 snaps into corresponding grid arm hinge portion 138 to allow middle grid flap 122 to rotate up and down above and below the zero plane of grid table 20. Middle grid flap bottom surface 126 includes socket 134 which engages male ball joint portion 132 of banjo cam arm 144. Middle grid flap top surface 124 is substantially flat.

Left and right trimmer assemblies 14 and 16 are identical to middle trimmer assemblies 12 except for their grid flap assemblies. Each left and right trimmer assembly 14, 16 includes the same trimmer stand 46, trimmer drive motor 66, grid flap motor 68 and banjo assembly 74 as the middle trimmer assemblies 12. Left and right grid flap assemblies 110 and 112 are essentially identical to each other, but include mirror image left and right grid arms 154 and 176, and trimmer head first and second shells, respectively, rigidly connected to their respective trimmer heads 60. Left grid arm 154 and right grid arm 176 connect to their respective trimmer heads 60 via first and second grid arm extension arms 156, 158 and 178, 180, respectively, laterally displaced from each other to form left and right grid arm channels 160 and 182 for its respective banjo cam arms 144 to move up and down against its respective left or right grid flap 162, 184. Each of left and right grid arms 154 and 176 include an upward projecting bumper portion 164, 186, respectively, which prevents product from displacing laterally off of grid table 20. Each of left and right grid flaps 162, 174 include a top surface 166, 188 and a bottom surface 168, 190. Each of left and right grid flap bottom surfaces 168, 190 includes a ball joint socket 170, 192 to receive a banjo cam arm ball joint portion 132, and a grid flap hinge portion 172, 194 which couples to a corresponding grid arm hinge portion 174, 196. Each of left and right grid flaps 162, 184 include concave first and second lateral bites 198, 202 and 200, 204, respectively, which provide clearance for the respective trimmer drive and idler wheels 70 and 72. Left and right grid flap top surfaces 166, 188 are substantially flat.

In the embodiment, left and right grid flaps 162 and 184 are slightly larger than middle grid flaps 122, extending laterally to match the additional width of left and right grid arms 154, 176 due to bumper portions 164, 186.

In the embodiment, each row of trimmer assemblies 12, 14, 16 is laterally offset from the preceding and succeeding rows by half the lateral distance between trimmer assemblies, allowing a denser arrangement of trimmer assemblies and to create overlapping coverage which prevent dead zone channels where product may get stuck or under-processed. In the embodiment, the left-right positions of trimmer drive wheels 70 and trimmer idler wheels 72 are reversed on each succeeding row, to avoid potential channelization of product moving along grid table 20 and allow denser layout of trimmer assemblies 12, 14, 16 by minimizing interference from protruding trimmer drive motors 66 and banjo motors 68.

Each banjo assembly 74 provides controllable up/down motion to grid flaps 122, 162, 184, which may oscillate in order to assist movement and rotation of product, or which may be set at a specific height to provide a fixed contact depth for the product engaging the trimmer wheels. Use of the banjo center ring 140 and banjo retaining ring 142 ensures the cam mechanism cannot overextend in either vertical direction. Alternative cam mechanisms could be used, such as pneumatic, geared or electromagnetic piston rods or cam shafts.

In the embodiment, the system includes a plurality of middle, left and right trimmer assemblies 12, 14, 16 with middle, left and right grid flap assemblies 108, 110, 112 mounted to a common base plate 18, a grid table shield 28, exhaust ventilation ports 34 connectable to an exhaust system, and electronic control system 102 in electronic control communication with each of the trimmer drive motors 66 and grid flap motors 68, as well as interconnected feed and discharge units 206 and 208, respectively.

Base plate 18 may be mounted on first and second trunnions 210 and 212, allowing angular adjustment about the longitudinal axis which translates to grid table 20. Base plate 18 may also be provided with vertical adjustment to create a selectable decline or incline angle along the length of grid table 20 to improve product flow.

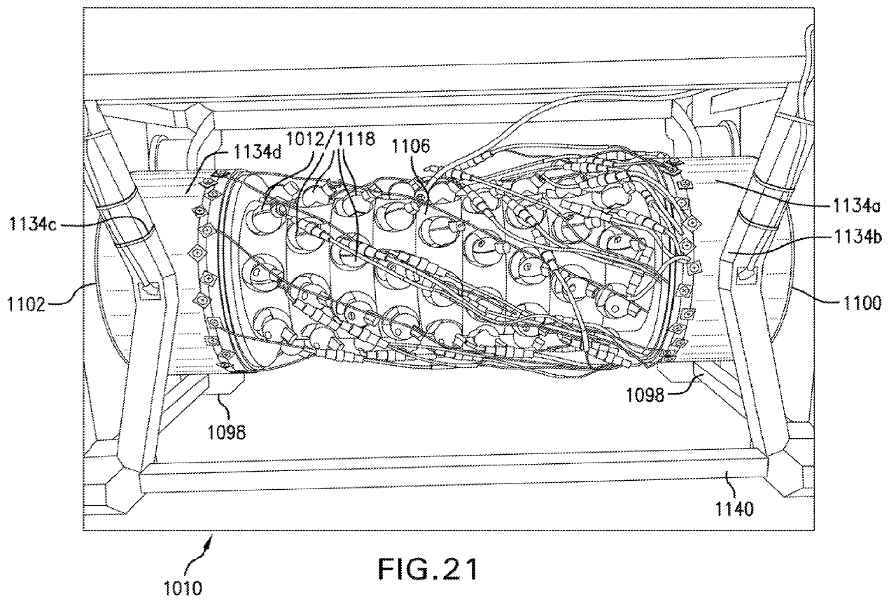

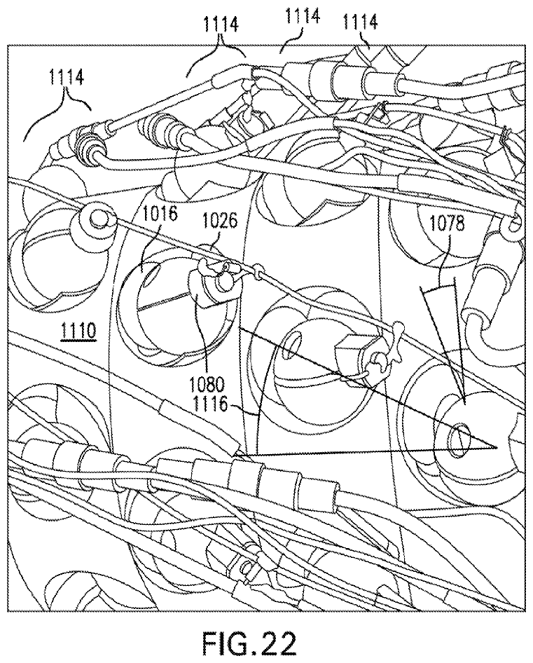

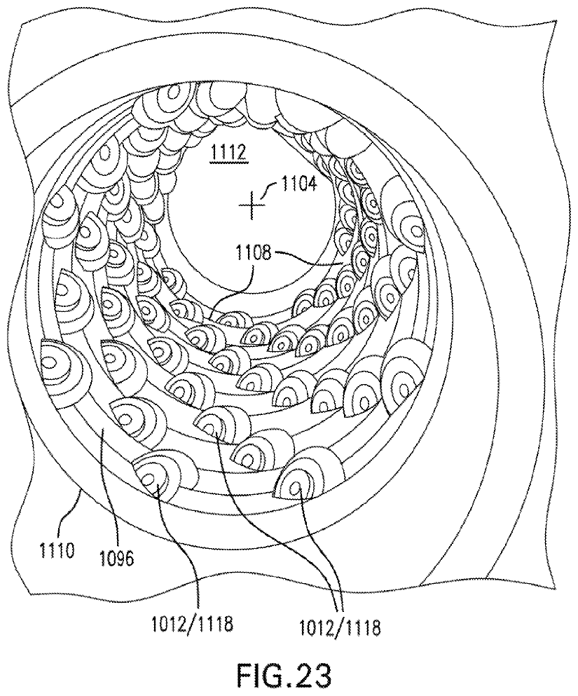

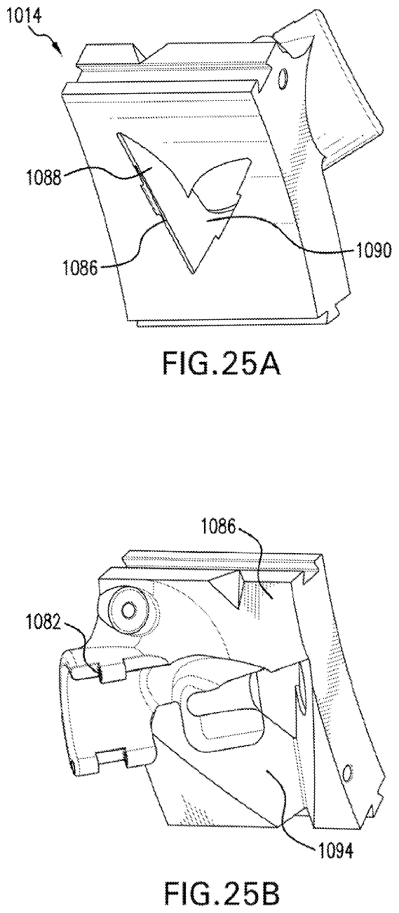

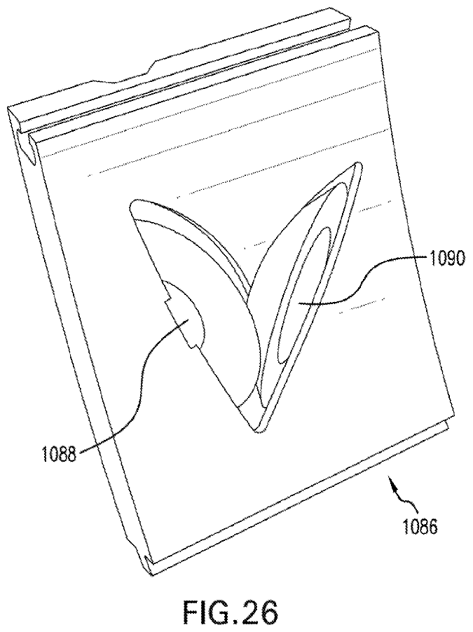

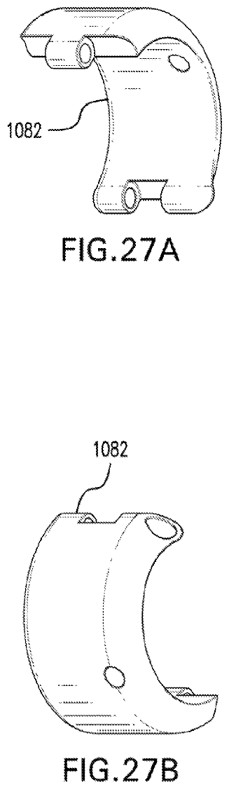

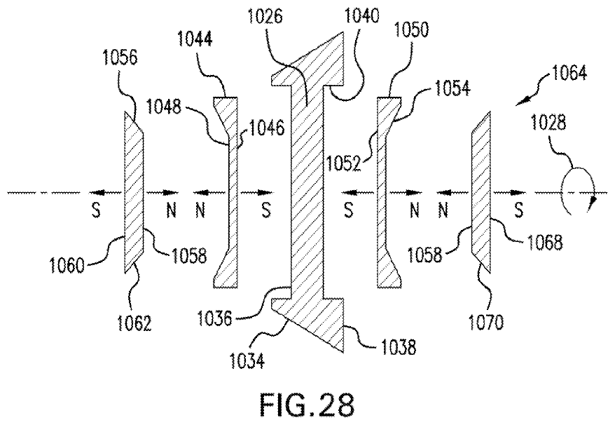

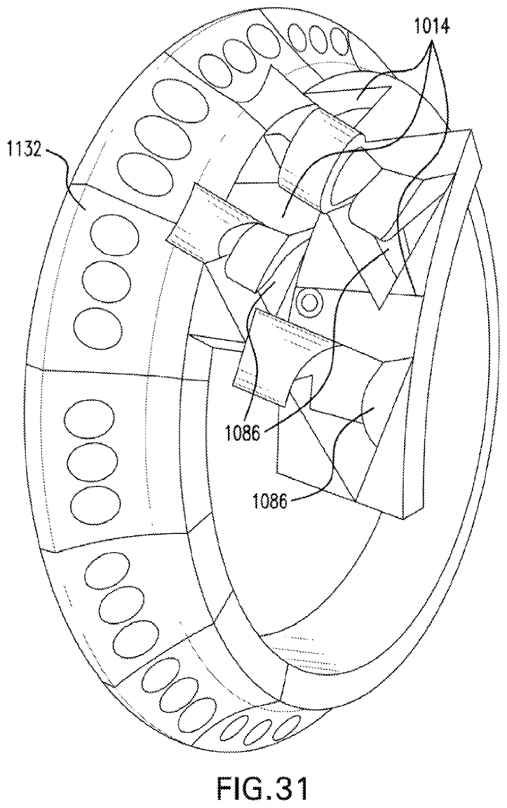

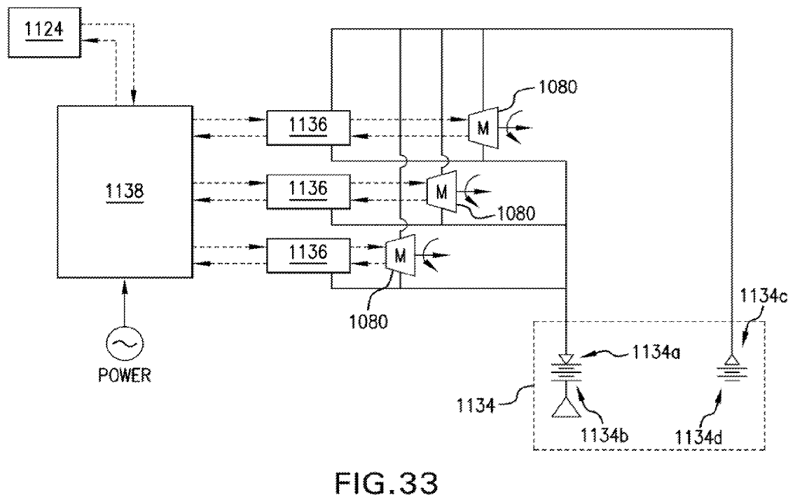

Referring to FIGS. 21-33, a second embodiment 1010 of a trimming apparatus is shown. Referring to FIGS. 21-24, trimming apparatus 1010 includes a plurality of identical trimmer head assemblies 1012 with a trimmer head assembly frame portions 1014. Trimmer head assembly 1012 includes a trimmer head assembly first wheel 1016 and trimmer head assembly second wheel 1024.

Trimmer head assembly first wheel 1016 rotates about a trimmer head assembly first rotational axis 1018. Trimmer head assembly first wheel 1016 includes a first wheel perimeter 1020 and first wheel perimeter surface 1022. In the embodiment, trimmer head assembly first wheel perimeter surface 1022 is beveled.

Trimmer head assembly 1012 includes a trimmer head assembly second wheel 1026. Trimmer head assembly second wheel 1026 rotates about a trimmer head assembly second rotational axis 1028. Trimmer head assembly second wheel 1026 includes a second wheel perimeter 1030 and second wheel perimeter surface 1032. In the embodiment, trimmer head assembly second wheel perimeter surface 1032 is beveled to match the beveled perimeter surface 1022 of trimmer head assembly first wheel 1016.

Trimmer head assembly drive motor 1080 is mounted to trimmer head assembly frame portion 1014 and rotationally coupled to trimmer head assembly first wheel 1016 along the trimmer head assembly first rotational axis 1018. Trimmer head assembly second wheel 1026 is also mounted with frame portion 1014 and freely rotates about trimmer head assembly second rotational axis 1028 supported by trimmer head assembly second wheel bearing assembly 1042. In the embodiment, trimmer head assembly first wheel 1016 is made from a high-strength hard material, such as aluminum or carbon fiber, and includes a contact layer of resilient high-friction material 1026 on at least the perimeter surfaces 1022. In the embodiment, first wheel contact layer 1026 extends over substantially the entire first wheel surface. In the embodiment, contact layer 1026 is silicone rubber, which provides good frictional contact with product (and therefore strong pull forces) and is nontoxic. The grip and resiliency of contact layer 1026 is more likely to actually pull a leaf from a product, rather than simply crushing or pinching-off the leaves at the frictional contact location 1072, and more effective at imparting an impulse force in the impulse angle/direction 1078 on a bud as it contacts trimmer head assembly first and second wheels 1016, 1026. Additionally, contact layer 1024 provides wear surfaces which can be replaced less expensively than wheels 1016 and produce less noise in operation.

Trimmer head assembly first and second wheels 1016, 1026, are mounted to be in frictional contact with each other at the frictional contact location 1072 on their respective perimeter surfaces 1022, 1032. For simplicity, frictional contact location 1072 will be treated as a point in space, but in actuality it defines a small area at which trimmer head assembly first and second wheels 1016, 1026, slightly compress against each other. References to the “position” or “depth” of the frictional contact location should be taken to refer to a centroid point of the area.

The camber angle 1074 between trimmer head assembly first and second rotational axes 1018, 1028, defines a non-zero angle. The bevel angles of perimeter surfaces 1022, 1032, respectively, of the trimmer head assembly first and second wheels 1016, 1026, is selected to ensure full contact of trimmer head assembly first and second wheel perimeter surfaces 1022, 1032, at frictional contact location 1072 for the selected camber angle 1074.

Trimmer head assembly second wheel 1026 is supported by its bearing assembly 1042, allowing free rotation about trimmer head assembly second rotation axis 1028 imparted by contact with trimmer head assembly first wheel 1016 coupled to trimmer head assembly drive motor 1080.

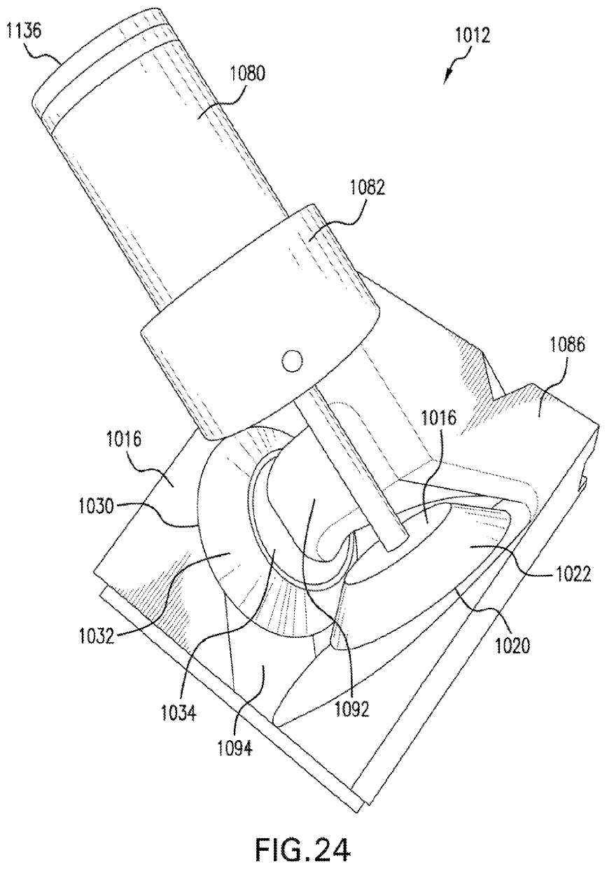

Referring to FIGS. 24 & 28, bearing assembly 1042 is a magnetic bearing system, including first and second magnetic retaining rings 1044, 1050, and corresponding first and second outer magnets 1056, 1064.

Trimmer head assembly second wheel 1026 includes first and second bearing races 1036, 1040, disposed on opposite first and second faces 1034, 1038, respectively. First and second bearing races 1036, 1040, retain first and second magnetic bearing retainer rings 1044, 1050, respectively. First and second magnetic bearing retainer rings 1044, 1050, are dimensionally and magnetically identical, and fixed into their respective first and second bearing races 1036, 1040. Each of first and second magnetic bearing rings 1044, 1050, include a magnetic retaining ring first face 1046, 1052, respectively, which is oriented toward the respective first and second bearing race, 1036, 1040, and a magnetic retaining ring second face 1048, 1054, respectively, which is oriented outward. Each of magnetic retaining ring second faces 1048, 1054, is beveled concave. First and second magnetic retaining rings 1044, 1050, are magnetized with the “north” pole oriented outward from the beveled magnetic retaining ring second faces 1048, 1054. First and second magnetic retaining rings 1044, 1050, are magnetized with the “south” pole oriented outward from the magnetic retaining ring first faces 1046, 1052, respectively.

First and second outer magnets 1056, 1064, are dimensionally and magnetically identical. Each of first and second outer magnets 1056, 1064, include a first face 1058, 1066, and a second face 1060, 1068, and beveled perimeters 1062, 1070, respectively. First and second outer magnet beveled perimeters 1062, 1070, match the bevel angles of first and second magnetic retaining ring second faces 1048, 1054. First and second outer magnets 1056, 1064, are magnetized with their “north” poles oriented outward from their respective first faces 1058, 1066 (i.e. oriented inward toward the bearing assembly), and their “south” poles oriented outward from their respective second faces 1060, 1068 (i.e. oriented outward away from the bearing assembly). First and second outer magnets 1056, 1064, are retained against opposed first and second interior walls 1092, 1094, of trimmer head assembly second wheel retaining portion 1090.

In this way, first and second outer magnets 1056 and 1064 magnetically oppose/repel each other and their corresponding magnetic retaining rings 1044, 1050, to support the bearing system 1042 in compression but without mechanical contact. This avoids potential contamination from bearing lubricants and wear particles. Magnetic bearing assembly 1042 provides for slight displacement of trimmer head assembly second wheel 1026 when trimmer head assembly 1012 grabs and pulls a leaf in between trimmer head assembly first and second wheels 1016 and 1026, which reduces risk of simply crushing and pinching off the leaf rather than pulling it from the product. The noncontact displacement ability also provides for using of high-speed-low-torque trimmer head assembly drive motors 1080, as the frictional contact location 1072 is only lightly compressed.

In the embodiment, first and second magnetic retainer rings 1044, 1050, and first and second outer magnets 1056, 1064, are neodymium permanent magnets with a corrosion-resistant metal-epoxy outer coating.

In the embodiment, trimmer head assembly second wheel 1026 is made from ceramic-coated aluminum, which is durable, substantially nonmagnetic, and effective at dissipating heat, and easily cleaned.

Referring to FIGS. 21-23, 29, 32, 34-35 a drum module 1098 of trimming apparatus 1010 is shown, with the plurality of trimmer head assemblies 1012 and frame portions 1014 mounted thereto in a distribution pattern 1118.

Drum module 1098 extends from a first end 1100 to a second end 1102. Drum module 1098 includes an annular drum module frame 1106 which is rotatable about the drum module rotation axis 1104. Drum module frame 1106 is annular, including an exterior surface 1110 and an interior surface 1108, the interior surface 1108 defining the continuous drum module interior volume 1112 extending from the drum module first end 1100 to the drum module second end 1102. The drum module frame interior surface 1108 defines a reference “zero depth” for describing relative position of the trimmer head assembly wheel positions.

Trimmer head assemblies 1012 are mounted to drum module frame 1106 so that trimmer head assembly first and second wheels 1016, 1026, partially project past drum module frame interior surface 1108 and into drum module interior volume 1112. The projection of the trimmer head assembly first and second wheels 1016, 1026, or more particularly the position of frictional contact location 1072 relative to the drum module interior surface/zero depth 1108 is referred to as the trimmer head depth 1096. A positive trimmer head depth means frictional contact location 1072 is past the zero depth and within drum module interior volume 1112. A trimmer head depth of 0 means frictional contact location 1072 is even with the drum module frame interior surface 1108. A negative trimmer head depth means frictional contact location 1072 is disposed outside the drum module frame interior surface 1108 and drum module interior volume 1112. Trimmer head depth 1096 may be fixed at a positive, negative or zero setpoint, or trimmer head assembly 1012 may include adjustment mechanisms, such as set screws, which can vary the trimmer head depth 1096 between some preselected range of values, either maximum negative-to-maximum positive or some lesser included range such as zero-to-negative or zero-to-positive.

Trimmer head assemblies 1012 are disposed along annular drum module frame 1106 in a distribution pattern 1118 intended to ensure adequate contact of product to a number of trimmer head assemblies 1012 as the product passes through rotating drum module 1098 during operation. Distribution pattern 1118 may be a uniform pattern of trimmer head assemblies distributed equidistantly along drum module frame 1106. Alternatively, trimmer head assemblies 1012 may be distributed around drum module frame 1106 in a series of drum module rings 1114, with each drum module ring rotated slightly in relation to the adjacent drum module rings, defining an drum module ring offset angle 1116. In the embodiment, drum module distribution pattern 1118 includes a series of seven drum module rings 1114 with sixteen trimmer head assemblies 1012 mounted along each drum module ring 1114.

In the embodiment, each trimmer head assembly 1012 is mounted to a trimmer head assembly frame portion 1014. Each trimmer head assembly frame portion 1014 includes a head assembly frame shield portion 1084 with shield aperture 1086 through which trimmer head assembly first and second wheels 1016, 1026, project through. Trimmer head assembly drive motors 1080 are mounted to head assembly frame shield portions 1084 by drive motor mounting brackets 1082, projecting externally from drum module 1098. Head assembly frame shield aperture 1086 includes a first wheel receiving portion 1088, and a second wheel retaining portion 1090 with opposed first and second sidewalls 1092, 1094, to go against and contain trimmer head assembly second wheel magnetic bearing assembly 1042. Trimmer head shield portions 1084 are connected together to form drum module rings 1114, and a plurality of drum module frame rings 1114 are connected together to form annular drum module frame 1106. Drum module connection collars 1132 are attached drum module frame 1106 proximate the drum module first and second ends 1100, 1102. Drum module connection collars 1132 provide connection locations for additional drum modules or ancillary assemblies such as slip ring assembly 1134, and act as stiffening flanges.

Each of trimmer head assemblies 1012 is aligned to produce a negative pull angle 1076, which means angled toward the exterior of drum module frame 1106 to pull off leaves and expel them out of drum module 1098.

Each of trimmer head assemblies 1012 imparts a force on a bud (or other product) when the product contacts the rotating trimmer head assembly first and second wheels 1016, 1026—referred to as the “impulse force”—which accelerates the bud past the trimmer head assembly. In the embodiment, each of trimmer head assemblies 1012 are aligned to impart an impulse force at a non-zero positive impulse angle 1078 relative to a transverse cross-section of drum module frame 1106. In this case, a 0° impulse angle 1078 would mean that the trimmer head assembly 1012 is aligned to impart an impulse force in a direction normal to drum module rotation axis 1104 (or parallel to the surface of a normal cross-sectional plane) and a 90° impulse angle 1078 would mean that the trimmer head assembly is aligned to impart an impulse force parallel to drum module rotation axis 1104 (or longitudinally along drum module frame interior surface 1108) toward drum module second end 1102. Typically, an impulse angle 1078 will be selected in the range 0° to 30°, in order to impart forward momentum on product without moving the product too quickly through drum module 1098, to ensure an adequate number of “contacts” by each product with multiple trimmer head assemblies 1012 to remove all leaves from the product. In the embodiment, each of trimmer head assemblies 1012 are aligned for an impulse angle of approximately 15°.

Typically, for a rotating drum system as in the second embodiment, trimmer head assemblies 1012 will be aligned to create a negative pull angle 1076 in the range of negative 15° to 40°, to provide a sharp yank on the leaves, as the rotating drum module 1098 is imparting rotational motion on the product itself. In the embodiment, trimmer head assembly first and second wheels 1016, 1026, rotate the opposite direction as drum module 1098 relative to drum module rotation axis 1104.

Trimming apparatus 1010 includes an electrical slip ring assembly 1134 which is coaxially coupled to drum module 1098 and rotates with it. Slip ring assembly 1134 includes a slip ring assembly first ring 1134a in electrical contact with slip ring assembly first brush 1134b, and slip ring assembly second ring 1134c in electrical contact with slip ring assembly second brush 1134d. Slip ring assembly 1134 provides power to trimmer head assembly drive motors 1080 and sensors mounted to drum module 1098. In the embodiment, slip ring assembly brushes 1134b and d are mechanically coupled to support frame 1140.

In the embodiment, each trimmer head assembly drive motor 1080 is a brushless DC motor of 22 mm frame size which is modified to include a circuit board mounted drive motor controller 1136 which provides wireless control and feedback communications with system controller 1138, thereby reducing the amount of wiring required and avoiding need for a separate slip ring assemblies for control and feedback communications.

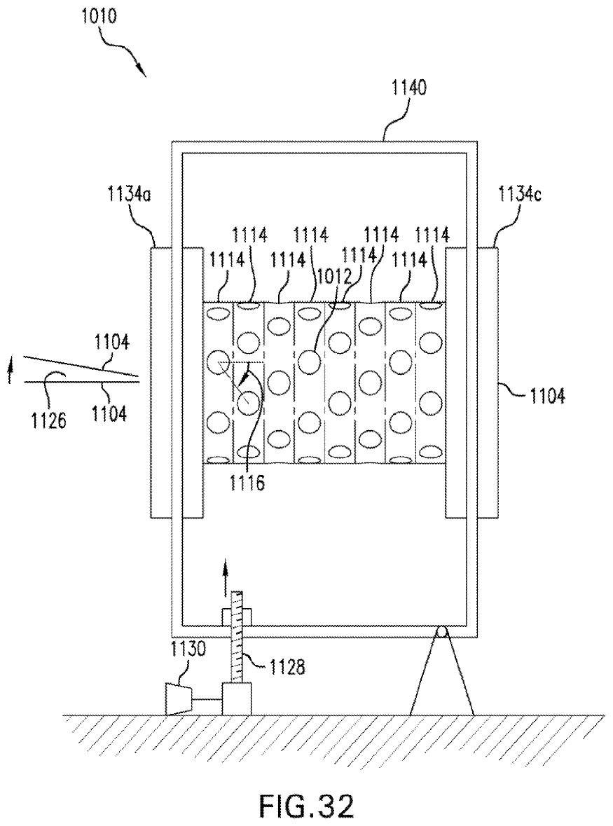

Referring to FIG. 32, trimming apparatus 1010 is shown with a drum rotational drive 1120 couplable to drum module 1098. In the embodiment, drum rotational drive 1120 is directly coupled to drum module drive wheel 1122. The drum module rotation speed would be determined based on the dimensions of drum module 1098 and trimmer head first and second wheels 1016, 1026, as well as the type of product being processed. In the embodiment, drum rotational drive 1120, with drum module 1098 being approximately 12 inches (30 cm) in diameter, would typically operate at less than 60 rpm when processing cannabis buds, but operating speeds would depend on many factors, including the type and condition of product to be processed, the size of the drum modules 1098, the number of trimmer head assemblies 1012 in the distribution pattern 1118, the pull angles and impulse angles of the trimmer head assemblies 1012, and the inclination angle 1126 of the drum module 1098, the desired throughput of the process, the required quality level of the process (e.g. whether it requires removing nearly 100% of leaves or only 80%, depending on the intended use) among other factors. Optimally, the rotation of the drum module 1098 will cause product to gently tumble as it passes along the interior surface 1108 of drum module 1098.

Referring to FIG. 32, a trimming apparatus 1010 includes an inclinator 1124, which adjusts the incline angle 1126 of drum module 1098 to increase or decrease the rate at which product moves through drum module 1098. In the embodiment, inclinator 1124 includes a lead screw 1128 coupled to a lead screw drive 1130 which is in control communication with system controller 1138.

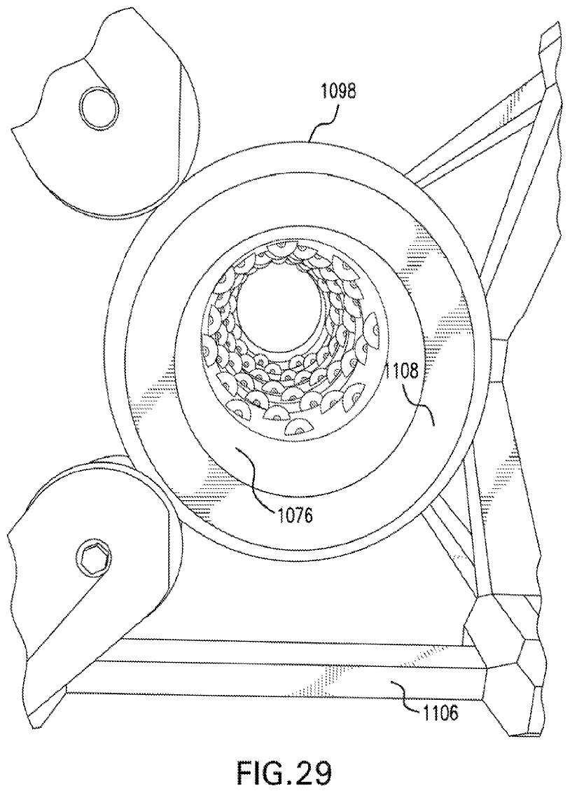

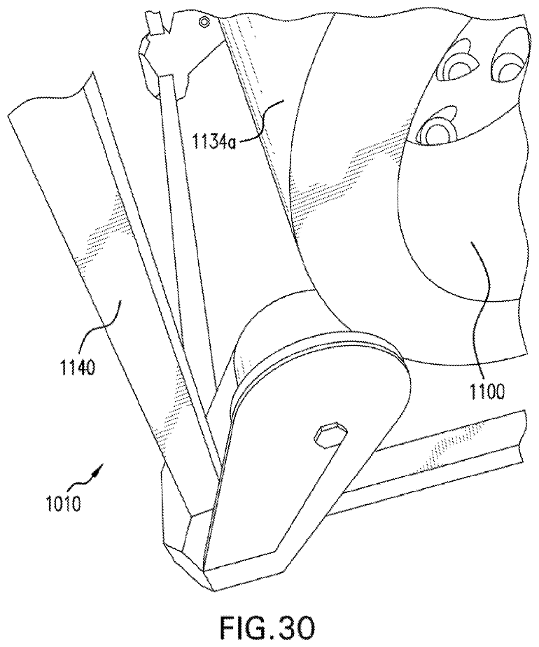

Referring to FIGS. 21 and 29, a trimming apparatus 1010 includes a support frame 1140.

Referring to FIGS. 21-33, in operation, drum module rotational drive 1120 rotates drum module 1098 as product is fed into drum module interior volume 1112 via drum module open first end 1100. Trimmer head assembly drive motors 1080 cause their respective trimmer head assembly first wheels 1016 to rotate at a selected speed, which causes the respective second wheels 1026 to rotate at the same speed but in the opposite direction through frictional contact. Rotating drum module 1098 causes product to tumble and come into contact with multiple trimmer head assemblies 1012, removing leaves or other projecting matter by the first and second wheels, 1016 and 1026, gripping the projecting matter between them and pulling it from the product at its base connection rather than simply cutting it off proximate to the surface of the product. Contact with the trimmer head assemblies also urges the product toward drum module second end 1102 and contact with additional trimmer head assemblies 1012, to ensure essentially all surface areas of the product come into contact with at least one, and preferably multiple trimmer head assemblies 1012. Removed material is ejected out of drum module 1098, to be collected for further processing or disposed of.

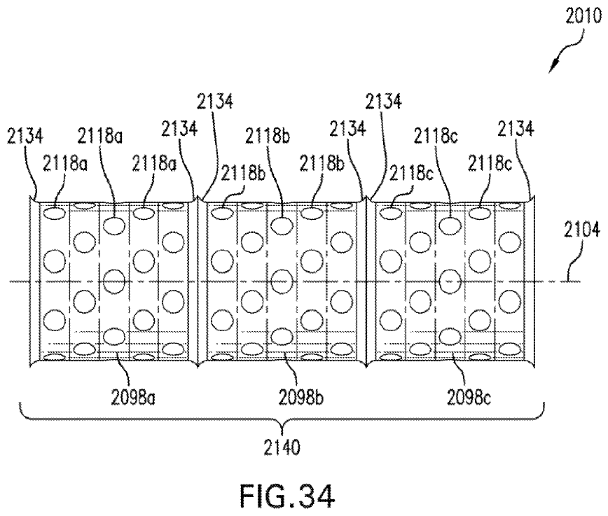

Referring to FIG. 34, a third embodiment of a trimming apparatus 2010 is shown, including first, second and third rotating drum modules 2098A, 2098B and 2098C, respectively, coupled together longitudinally at drum module connection collars 2134 to form a processing cylinder 2140 with continuous interior volume 2112 and continuous central rotation axis 2104. First and third drum module trimmer head assembly distribution patterns 2118A & C include seven rings of sixteen trimmer head assemblies 2012 with offset angles 2116 of approximately 20°. Second drum module 1098 includes a trimmer head assembly distribution pattern 2118B with six rings of fifteen trimmer head assemblies 2012 with offset angles 2116 of approximately 20°. This combination of distribution patterns provides three-hundred-and-twenty trimmer head assemblies 2012 distributed along processing cylinder 2140.

Although the demonstrative embodiments show drum modules as right cylinders, drum modules could also be conical or other cross-sectional shapes, and a processing cylinder could include different types of drum modules in series. For example, referring to FIG. 34, a processing cylinder 2140A is shown including a first drum module 2098D which is conical coupled to a second drum module 2098E which is a right cylinder. A drum module/processing cylinder portion could also be combined with a flat conveyor apparatus, as described in the first embodiment 10. A trimmer apparatus 10, 1010 and/or 2010 may be combined with a continuous feed system, a batch feed system, or a manual feed system, or a combination of these. The apparatus claimed and described is modular and scalable, and easily integrated into existing processing systems.

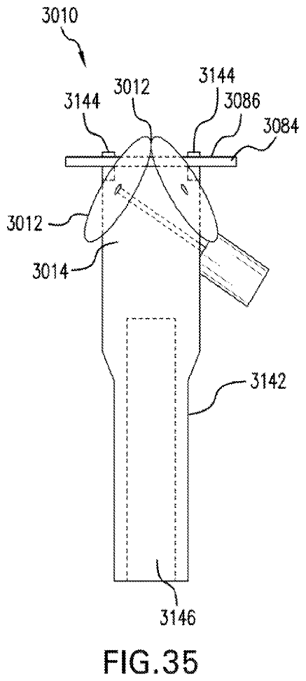

Referring to FIG. 35, a fourth embodiment of a trimming apparatus 3010 is shown. In the embodiment, a trimmer head assembly 3012 (essentially as described in the second embodiment 1010) is mounted with a trimmer head assembly frame portion 3014 which includes handle portion 3142. Handle portion 3142 is adapted to receive a selected rechargeable battery 3146, which may be removable. Trimmer head assembly frame portion 3014 includes depth-control shield 3084 which allows the user to adjust the head depth 3096. Depth-control shield 3084 includes a front side 3086 which goes against the product to be trimmed and a back side 3088, and adjustable threaded spacers 3144 to adjust the head depth 3096.

In operation, an operator holds trimming apparatus 3010 by handle portion 3142 and manually moves it along the surface of product to contact trimmer head assembly 3012 to leaves or portions to be removed from the product.

Those skilled in the art will recognize that numerous modifications and changes may be made to the preferred embodiment without departing from the scope of the claimed invention. It will, of course, be understood that modifications of the invention, in its various aspects, will be apparent to those skilled in the art, some being apparent only after study, others being matters of routine mechanical, chemical and electronic design. No single feature, function or property of the preferred embodiment is essential. Other embodiments are possible, their specific designs depending upon the particular application. As such, the scope of the invention should not be limited by the particular embodiments herein described but should be defined only by the appended claims and equivalents thereof.

I claim:

1. A trimming apparatus, comprising a trimmer head assembly and trimmer head frame portion:
the trimmer head assembly including a first trimmer head assembly wheel having a first trimmer head assembly rotational axis and a first trimmer head assembly wheel perimeter surface, a trimmer head assembly second wheel having a trimmer head assembly second rotation axis and trimmer head assembly second wheel perimeter surface, a trimmer head assembly drive motor coupled to the trimmer head assembly first wheel, the trimmer head assembly first wheel and trimmer head assembly second wheel rotationally mounted within the trimmer head assembly frame portion, the trimmer head assembly first and second wheels in frictional contact with each other at a location on their respective perimeter surfaces, wherein the trimmer head assembly first and second rotational axes define a non-zero trimmer head assembly camber angle.

2. A trimming apparatus as in claim 1, further comprising:
the trimmer head frame portion including a trimmer head second wheel retaining portion, the second wheel retaining portion including opposed first and second walls and a magnetic bearing assembly to support the trimmer second wheel within the second wheel retaining portion between the retaining portion first and second walls;
each trimmer head assembly second wheel further comprising first and second wheel faces on opposite sides of the trimmer head assembly second wheel, the first and second wheel faces including a first and second bearing race, respectively; and,
each magnetic bearing assembly comprising:
first and second magnetic bearing retaining rings retained within the corresponding first and second bearing races, and first and second outer magnets retained against the retaining portion first and second walls opposed to the respective first and second magnetic bearing retaining rings, each of the first and second magnetic bearing retaining rings including magnetic material defining identical retaining ring magnetic polarities, and each of the first and second outer magnets including magnetic material defining identical outer magnet magnetic polarities;
wherein the first and second magnetic bearing retaining rings are oriented with their retaining ring magnetic polarities in repulsion to each other, and the first and second outer magnets are oriented with their outer magnet magnetic polarities in repulsion to each other and in repulsion to their corresponding first and second magnetic bearing retaining ring magnetic polarities.

3. A trimming apparatus as in claim 1, further comprising:
a plurality of trimmer head assemblies;
a drum module extending from a drum module first end to a drum module second end, the drum module comprising a drum module annular frame rotatable about the drum module central longitudinal axis, the drum module annular frame including an exterior surface and an interior surface, the interior surface defining a continuous drum module interior volume extending from the drum module first end to the drum module second end and the interior surface further defining the drum module zero depth;
the plurality of trimmer heads mounted to the drum module frame with the trimmer head first and second wheels partially projecting past the drum module frame interior surface zero depth into the drum module interior volume to a trimmer head depth, the direction of movement of the trimmer first wheel and trimmer second wheel at the frictional contact location relative to the zero depth defines the pull angle and the direction of movement of the trimmer first wheel and trimmer second wheel at the frictional contact location relative to the central longitudinal axis defining the impulse angle;
wherein the plurality of trimmer heads are mounted to the drum module frame in a trimmer head distribution pattern.

4. A trimming apparatus as in claim 3, further comprising wherein the trimmer head depth is 0 mm.

5. A trimming apparatus as in claim 3, further comprising wherein the trimmer head depth is positive.

6. A trimming apparatus as in claim 3, further comprising wherein the trimmer head depth is negative.

7. A trimming apparatus as in claim 3, further comprising wherein the trimmer head depth is adjustable within a range of a maximum negative setting to a maximum positive setting.

8. A trimming apparatus as in claim 3, further comprising:
a drum rotational drive couplable to the drum module.

9. A trimming apparatus as in claim 3, further comprising:
the distribution pattern comprising the plurality of trimmer heads are disposed throughout the drum frame interior surface equidistantly from each other.

10. A trimming apparatus as in claim 3, further comprising:
the distribution pattern comprising a plurality of rings disposed longitudinally along the length of the drum module, each ring defining a circumferential cross-section of the drum module frame and including an equal group of trimmer heads disposed equidistantly along the ring circumference, wherein each respective group of trimmer heads of each ring is offset from the immediately preceding ring by an offset angle measured around the central longitudinal axis.

11. A trimming apparatus as in claim 9, further comprising:
wherein each offset angle is selected to be in the range of 10 degrees to 40 degrees.

12. A trimming apparatus as in claim 9, further comprising:
wherein each offset angle is equal and the value of the offset angle is selected to be in the range of 10 degrees to 30 degrees.

13. A trimming apparatus as in claim 3, further comprising:
a plurality of drum modules coaxially coupled together to form a processing cylinder having a continuous interior volume and continuous central longitudinal axis, the processing cylinder rotatable about the processing cylinder central longitudinal axis.

14. A trimming apparatus as in claim 13, further comprising:
a drum rotational drive couplable to at least one of the plurality of drum modules.

15. A trimming apparatus as in claim 3, further comprising:
an electrical slip ring assembly coaxially coupled to the drum module and rotatable with the drum module, the electrical slip ring assembly in electrical communication with the drive motors of the plurality of trimmer heads and couplable to an electrical power source.

16. A trimming apparatus as in claim 13, further comprising:
at least one electrical slip ring assembly coaxially coupled to at least one of the plurality of drum modules and rotatable with the processing cylinder, the electrical slip ring assembly in electrical communication with the drive motors of the plurality of trimmer heads of the respective drum modules and couplable to an electrical power source.

17. A trimming apparatus as in claim 16, further comprising:
the plurality of drum modules consisting of a first, second and third drum module.

18. A trimming apparatus as in claim 10, further comprising:
first, second and third drum modules coaxially coupled together to form a processing cylinder having a continuous interior volume and continuous central longitudinal axis, the processing cylinder rotatable about the processing cylinder central longitudinal axis;
a drum rotational drive couplable to at least one of the plurality of drum modules;
at least one electrical slip ring assembly coaxially coupled to at least one of the first, second and third drum modules and rotatable with the processing cylinder, the electrical slip ring assembly in electrical communication with the drive motors of the plurality of trimmer heads of the respective drum modules and couplable to an electrical power source.

19. A trimming apparatus as in claim 18, further comprising:
the first and third drum module distribution patterns consisting of seven rings, and the second drum module distribution pattern consisting of six rings.

20. A trimming apparatus as in claim 19, further comprising:
each of the rings of the first and third drum module distribution patterns including an equal number of trimmer heads.

21. A trimming apparatus as in claim 20, further comprising:
each of the rings of the second drum module distribution pattern having a different number of trimmer heads than the rings of the first and third drum module distribution patterns.

22. A trimming apparatus as in claim 3, further comprising:
wherein the drum module interior surface defines a right cylinder of constant circular cross-section.

23. A trimming apparatus as in claim 3, further comprising:
wherein the drum module interior surface defines a conical right frustum.

24. A trimming apparatus as in claim 3, further comprising:
a feeder in communication with the drum module first end.

25. A trimming apparatus as in claim 3, further comprising:
an inclinator couplable to the drum module.

26. A trimming apparatus as in claim 3, further comprising:
wherein the pull angle is negative.

27. A trimming apparatus as in claim 3, further comprising:
wherein the pull angle is in the range of 15° to 40°.

28. A trimming apparatus as in claim 3, further comprising:
wherein the impulse angle is non-zero.

29. A trimming apparatus as in claim 3, further comprising:
wherein the impulse angle is selected in the range 10 degrees to 45 degrees.

30. A trimming apparatus as in claim 3, further comprising:
a system enclosure including an enclosure wall defining a system enclosure interior volume, the enclosure wall extending around at least the drum module, the system enclosure connectable to a ventilation system.

31. A trimming apparatus as in claim 30, further comprising:
wherein the system enclosure wall includes a plurality of removable panels providing access to the system enclosure interior volume.

32. A trimming apparatus as in claim 3, further comprising:
a trimmer head assembly second wheel made from retaining pocket having opposed first and second retaining pocket walls and a magnetic bearing assembly to support the trimmer second wheel within the second wheel retaining pocket between the first and second retaining pocket walls;
each trimmer head assembly second wheel further comprising first and second wheel faces on opposite sides of the trimmer head assembly second wheel, the first and second wheel faces including a first and second bearing race, respectively; and,
each magnetic bearing assembly comprising:
first and second magnetic bearing retaining rings retained within the corresponding first and second bearing races, and first and second outer magnets retained against the first and second retaining pocket walls opposed to the respective first and second magnetic bearing retaining rings, each of the first and second magnetic bearing retaining rings including magnetic material defining identical retaining ring magnetic polarities, and each of the first and second outer magnets including magnetic material defining identical outer magnet magnetic polarities;
wherein the first and second magnetic bearing retaining rings are oriented with their retaining ring magnetic polarities in repulsion to each other, and the first and second outer magnets are oriented with their outer magnet magnetic polarities in repulsion to each other and in repulsion to their corresponding first and second magnetic bearing retaining ring magnetic polarities.

33. A trimming apparatus as in claim 3, further comprising:
a controller in control communications with each respective trimmer assembly drive motor, the controller including instructions to activate and deactivate the respective trimmer assemblies to de-leaf and pass product through the drum module in the direction of the process path.

34. A trimming apparatus as in claim 1, further comprising:
a trimmer head frame portion including a handle, the handle further including an electrical power connector in electrical communication with the trimmer drive motor, the trimmer head frame portion coupled to the trimmer base portion.

35. A trimming apparatus as in claim 34, further comprising:
the trimmer base portion including a rechargeable power supply, the power supply electrically couplable to the trimmer drive motor.

36. A trimming apparatus (hand held) as in claim 34, further comprising:
a depth-control shield extending at least partially around the first wheel and second wheel proximate their frictional contact location, the depth-control shield including a front side to contact an object to be trimmed and a back side;
a depth adjuster coupled to the depth-control shield and the handle.

37. A trimming apparatus (hand held) as in claim 36, further comprising:
the depth-control shield further including one or more springs coupled to the depth-control shield back side.

38. A trimming apparatus as in claim 1, further comprising:
a first group of trimmer head assemblies, each of the first plurality of trimmer head assemblies further including a grid flap assembly, each grid flap assembly including a grid flap hingedly coupled to the trimmer head frame proximate the upstream side of the trimmer first and second wheels and able to rotate at least between a first grid flap position above the frictional contact location of the trimmer first and second wheels and a second grid flap position below the frictional contact location of the trimmer first and second wheels, and a vertical reciprocator movably coupled to the grid flap to move the grid flap at least between the first and second grid flap positions;
the first plurality of trimmer head assemblies distributed in a planar pattern defining a process path.
continuous pattern on the base plate defining a grid table and a process path

39. A trimming apparatus as in claim 38, further comprising:
second and third pluralities of trimmer head assemblies disposed, respectively, along opposed right and left lateral sides of the first plurality of trimmer head assemblies;
each of the trimmer head assemblies of the second plurality of trimmer heads further including an right-hand bumper;
each of the trimmer head assemblies of the third plurality of trimmer heads further including a left-hand bumper.

40. A trimming apparatus as in claim 38, further comprising:
a controller in control communications with the respective trimmer drive motors and trimmer vertical reciprocators of the plurality of trimmer assemblies, the controller including instructions to activate and deactivate the respective trimmer assemblies to de-leaf infructescences and pass them along the grid table at least in the direction of the process path.
